(19) United States
(12) Patent Application Publication
(10) Pub. No.: US 2017/0103425 A1
(43) Pub. Date: Apr. 13, 2017

(54) SYSTEM AND METHOD FOR GENERATING CHALLENGES AND AWARDING PROMOTIONAL AWARDS THROUGH A GAMIFIED NETWORK

(71) Applicants: Fani Christofi, Bimingham (GB); Aristarchos Christofi, Bimingham (GB)

(72) Inventors: Fani Christofi, Bimingham (GB); Aristarchos Christofi, Bimingham (GB)

(21) Appl. No.: 15/279,678

(22) Filed: Sep. 29, 2016

Related U.S. Application Data
(60) Provisional application No. 62/238,388, filed on Oct. 7, 2015.

(51) Int. Cl. G06Q 30/02; G06Q 50/00; G07F 17/32; H04L 29/06

(52) U.S. Cl. CPC G06Q 30/0269; H04L 67/38; G06Q 30/0255; G06Q 30/0277; G06Q 50/01; G07F 17/3225; G07F 17/3255

(57) ABSTRACT

A system and method for generating challenges and awarding promotional awards through a gamified social network. The system and method creates a competitive challenge through a network, such as a social network, by providing challenges that have a theme, and enabling a user or a group in a network to participate in performing, evaluating, commenting, and receiving promotional awards based on achievement of the challenge. The method enables users to participate in the challenge alone or challenge group members of the network to participate in the challenge. Users can evaluate performance of the challenge, the user, or the group participating in the challenge. Users can interact with the group and the network about the challenges or performance of the user or group. Promotional awards can be awarded to the user or group who successfully accomplishes the challenge, so as to monetize the system and method.

This application claims the benefit of U.S. Provisional Application No. 62/238,388, filed on Oct. 7, 2015.

### FIELD OF THE INVENTION

The present invention relates generally to a system and method for generating challenges and awarding promotional awards through a gamified network. More so, the present invention relates to a system and method that enhances participation in a social network by applying game elements and game principles to a social network, such that users can play the game alone or challenge other users of the network to play the game, users can evaluate performance of the game and other users in the network, users can interact with each other about the challenges or performance of other users, and promotional awards can be awarded to users who successfully accomplished the challenge, so as to monetize the system and method.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, gamification is a technique by which game mechanics are applied to non-gaming applications in order to increase user engagement, motivation, and participation. Electronic gaming services including online contests, sweepstakes, games of chance, wagering games, such as video slots, video poker, and the like, are available for play from various internet-based sites. Increasingly more gaming services are also provided in conjunction with internet-based advertisements to create incentives for participating in a game and to promote an end-product or service.

Often, gamification is the practice of adding game like elements to reward behavior in a non-game setting. It can be thought of as: getting points every time you brush your teeth. Or an award for doing the laundry. Or washing the car. I'd like a prize for doing the dishes. A social network has been gamified.

It is known that an online community is a virtual community where users interact with each other via the Internet or any communication network (web site, email, instant messaging, mobile application, etc.), usually with some common theme. Unlike a traditional website, in which the website owner controls all of the content, an online community enables and encourages users to participate in the content. Users post comments, replies to comments, questions, and answers to other users' questions; more experienced users develop articles and knowledge bases, and lead forum discussions or blogs.

The usefulness of an online community, however, depends on the active involvement of the users. Sometimes a user may visit the website for the online community one time, and not return. Other users may access the website only when there is an immediate pressing question. Therefore, there is a need to promote greater user participation in the online communities provided by companies and organizations.

Other proposals have involved gamified networks. The problem with these gamified systems is that they do not generate great competitive excitement between members. Also, monetization is not always efficient, or not available at all. Even though the above cited gamified networks meets some of the needs of the market, a system and method for generating challenges and awarding promotional awards through a gamified social network by providing challenges, and enables a user or a group in a network to participate in posting, performing, evaluating, commenting, and receiving promotional awards based on the challenge is still desired.

### SUMMARY

Illustrative embodiments of the disclosure are generally directed to a system and method for generating challenges and awarding promotional awards through a gamified network. The system and method creates a unique challenge through a network, such as a social network, by providing challenges that have a general theme. The system and method enables a user or a group in a network to participate in creating the challenge, performing the challenge, evaluating the challenge or user, commenting on the challenge or user, and awarding promotional awards based on the challenge.

In essence, the system and method gamifies the social network through challenges that create competitive excitement and provide entertainment and education, while also monetizing the network through promotional awards that display marketing indicia and other marketing means known in the art.

The gamified social network enables a user or group in a network to present a challenge to each other. The network can be used for any type of challenge, be it sports, education, creativity, lifestyle, etc. The user or group may accept and participate in the challenge, either alone against a program, or against other members of the group in the network. The challenge may be measurable (quantifiable), or immeasurable (based on group member opinions). The challenge may also integrate marketing methods into the creation, participation, and awarding of promotional awards for the challenge.

In response to a received challenge, the user participates in the challenge alone against a program or other members of the group or any user within the network. The user or group may evaluate the performance of the challenge, and the performance of other users participating in the challenge. The evaluation may be based on measurable units or immeasurable votes from other users. A scoring system may be used to evaluate the challenge or user.

The user and the group may also comment and share information about the challenge or user performing the challenge. This may include approvals, disapprovals, advice, and general chatting. In this manner, users can interact with the group and the network about the challenges, achievements or performance of the user or group.

After a challenge is accomplished, promotional awards can be awarded to the successful user or group. Promotional awards can be awarded to the user or group who successfully accomplishes the challenge, so as to monetize the system and method. The promotional awards may include awards comprising marketing indicia. The promotional awards serve to monetize the system and method. Other monetizing tools may include user fees, advertisements, and promotional plans.

In one exemplary embodiment, the method for generating challenges and awarding promotional awards through a gamified social network comprises an initial Step of registering a user. In some embodiments, a prospective user may first register an account. The registration may determine the status of the user within the system. Registration may require the user to provide data, including, without limitation, input personal information, contact information, preferred challenges, and consumer history. Once registered as a user with a user type, the registered user may participate in and create challenges, join a group, participate in activities with members of the group and access other users.

The method may include an additional Step of joining, by the user, a group that forms a network. The network may include, without limitation, a social network, a work-related network, a shopping network, a consumer network, and an educational network. The members of the group may have like-minded views on a specific subject.

The method may further comprise a Step of presenting a challenge to the user or the group. The challenge may include an activity or achievement-related activity involving another member of the group or a member of the system. The types of challenges may include, without limitation: a measurable challenge, an immeasurable challenge, a direct challenge between user or group members, a logo challenge, a sponsored challenge, a cooperation challenge, a target challenge, a pay to participate challenge, a money reward challenge; a prize reward challenge; a dare from another user or group member, and a predefined challenge.

A Step comprises accepting the challenge alone against a program, or against the group. The user has the option of accepting or rejecting the challenge. The user may also request a different challenge.

A Step includes evaluating the challenge, or the performance of the challenge by the user or the group. During the performance of the activity evaluation of a user may take place by other users through a form of votes, termed respects (for immeasurable activities), or automatically by the system for measurable or pre-defined activities. Evaluation rankings are formed, and the winners may be identified and presented by the system, along with the type of activity performed by the winner.

A Step may include communicating about the challenge or the user or the group performing the challenge, the communication being operable between the user, the group, and the network. Users of the system may stay connected through a number of means. Users may receive notifications within the network, through email or text that relate to updates on actions and activities that affect them. In communicating, the user or group may also socialize through blogs and chat rooms or groups. A comment plug-in may also be used to help connect the user with the group, such that friendships and associations can form therebetween. Furthermore, status updates and new feeds about user or group interests may also be announced and shared.

In one embodiment, the user or group shows approval in multiple ways. The user or group may select a desired action or manner of performing the challenge. This helps to gamify the challenge, and thereby the network. In some embodiments, the user or group may indicate approval with a respect action, which is similar to a like action or a vote action. The respect action indicates approval or support for a challenge, action, user, or group performing the challenge. In another embodiment, the user or group can nominate each other for a challenge based on certain characteristics or qualities of the nominee. The user or group may also nominate others outside the network in other networks, including potential members and users.

In some embodiments, a Step comprises awarding a promotional award to the user or the group that successfully accomplish an achievement of the challenge, the promotional award comprising a marketing indicia. The promotional award is configured to provide the dual function of indicating success of the user or group, and promoting a product or service. In this manner, monetization of the method is possible. The types of achievements that warrant a promotional award may include, without limitation, a measurable achievement, an immeasurable achievement, a beat achievement function, and a sponsored achievement.

The method may further include a Step of monetizing the network. In some embodiments, the method may implement additional marketing tools, beyond the promotional award, including: charging users and groups fees, advertising fees, promotional fees, and purchasing tangible or intangible products or services while performing the challenge.

In some embodiments, an alternative Step may include providing a proof that the challenge has been completed or successfully accomplished. The completion and result of an activity task may be demonstrated by proof. The winner of the challenge may receive a trophy or reward, which may be in tangible, intangible, or in monetary form.

Another alternative Step comprises setting privacy parameters by the user or the group in the network. Privacy settings and file sharing are also variable options.

One objective of the present invention is to gamify a network, and especially a social network.

Another objective is to create entertaining and educational challenges for and between group members of a network.

Yet another objective is to allow group members to communicate through the network with comments, likes, respects, advice, and images.

Another objective is to integrate advertising and monetization into the creation, participation, and successful completion of the challenge or achievement.

Yet another objective is to monetize a gamified network through promotional awards.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for generating challenges and awarding promotional awards through a gamified network, in accordance with an embodiment of the present invention;

FIG. 2 illustrates a flowchart of an exemplary method for generating challenges and awarding promotional awards through a gamified network, in accordance with an embodiment of the present invention;

FIG. 3 illustrates a flowchart of an exemplary registration process, in accordance with an embodiment of the present invention;

FIG. 4 illustrates a flowchart of an exemplary process for joining a group, in accordance with an embodiment of the present invention;

FIG. 5 illustrates a flowchart of an exemplary process for evaluation of the user, group member, or challenge, in accordance with an embodiment of the present invention;

FIG. 6 illustrates a flowchart of an exemplary process for providing proof of completion of the challenge, in accordance with an embodiment of the present invention;

FIG. 7 illustrates a flowchart of an exemplary promotional award in the form of a trophy, in accordance with an embodiment of the present invention;

FIG. 8 illustrates a flowchart of an exemplary process for a user challenge, in accordance with an embodiment of the present invention;

FIG. 9 illustrates a flowchart of an exemplary process for a sponsored challenge, in accordance with an embodiment of the present invention;

FIG. 10 illustrates a flowchart of an exemplary process for a dare challenge, in accordance with an embodiment of the present invention;

FIG. 11 illustrates a flowchart of an exemplary process for a target challenge, in accordance with an embodiment of the present invention;

FIG. 12 illustrates a flowchart of an exemplary process to create a challenge between multiple users and group members, in accordance with an embodiment of the present invention;

FIG. 13 illustrates a flowchart of an exemplary process for a logo challenge, in accordance with an embodiment of the present invention;

FIG. 14 illustrates a flowchart of an exemplary process for a money reward challenge, in accordance with an embodiment of the present invention;

FIG. 15 illustrates a flowchart of an exemplary process for a prize reward challenge, in accordance with an embodiment of the present invention;

FIG. 16 illustrates a flowchart of an exemplary process for evaluating a measurable challenge, in accordance with an embodiment of the present invention;

FIG. 17 illustrates a flowchart of an exemplary process for evaluating an immeasurable challenge, in accordance with an embodiment of the present invention;

FIG. 18 illustrates a flowchart of an exemplary Fastest Typing challenge, in accordance with an embodiment of the present invention;

FIG. 19 illustrates a flowchart of an exemplary More Screenshots challenge, in accordance with an embodiment of the present invention;

FIG. 20 illustrates a flowchart of an exemplary process for a measurable achievement, in accordance with an embodiment of the present invention;

FIG. 21 illustrates a flowchart of an exemplary process for an immeasurable achievement, in accordance with an embodiment of the present invention;

FIG. 22 illustrates a flowchart of an exemplary process for a sponsored achievement, in accordance with an embodiment of the present invention;

FIG. 23 illustrates a flowchart of an exemplary process for a beat achievement, in accordance with an embodiment of the present invention;

FIG. 24 illustrates a flowchart of an exemplary process for collecting fees, in accordance with an embodiment of the present invention;

FIG. 25 illustrates a flowchart of an exemplary process for achieving an advertising marketing tool, in accordance with an embodiment of the present invention;

FIG. 26 illustrates a flowchart of an exemplary process for achieving a promotional plan, in accordance with an embodiment of the present invention;

FIG. 27 illustrates a flowchart of an exemplary process of accessing an activity board, in accordance with an embodiment of the present invention;

FIG. 28 illustrates a flowchart of an exemplary chat process, in accordance with an embodiment of the present invention;

FIG. 29 illustrates a flowchart of an exemplary friend request process, in accordance with an embodiment of the present invention;

FIG. 30 illustrates a flowchart of an exemplary following process, in accordance with an embodiment of the present invention;

FIG. 31 illustrates a flowchart of an exemplary nominating process, in accordance with an embodiment of the present invention;

FIG. 32 illustrates a flowchart of an exemplary sharing process, in accordance with an embodiment of the present invention;

FIG. 33 illustrates a flowchart of an exemplary search process, in accordance with an embodiment of the present invention;

FIG. 34 illustrates a flowchart of an exemplary privacy setup process with a key, in accordance with an embodiment of the present invention;

FIG. 35 illustrates a flowchart of an exemplary process to achieve different levels in the network, in accordance with an embodiment of the present invention;

FIG. 36 illustrates a flowchart for obtaining a promotional award in the form of a medal, in accordance with an embodiment of the present invention;

FIG. 37 illustrates a flowchart for a hall of fame, in accordance with an embodiment of the present invention;

FIG. 38 illustrates a block diagram illustrating a hardware and software environment within which the network may be deployed, in accordance with an embodiment of the present invention;

FIG. 39 illustrates a block diagram showing the process by which a user registers for the network connects to social networks and through hardware and software, in accordance with an embodiment of the present invention; and

FIG. 40 illustrates a flowchart of an exemplary process for operation of a key teaser, in accordance with an embodiment of the present invention.

Like reference numerals refer to like parts throughout the various views of the drawings.

### DETAILED DESCRIPTION OF THE INVENTION

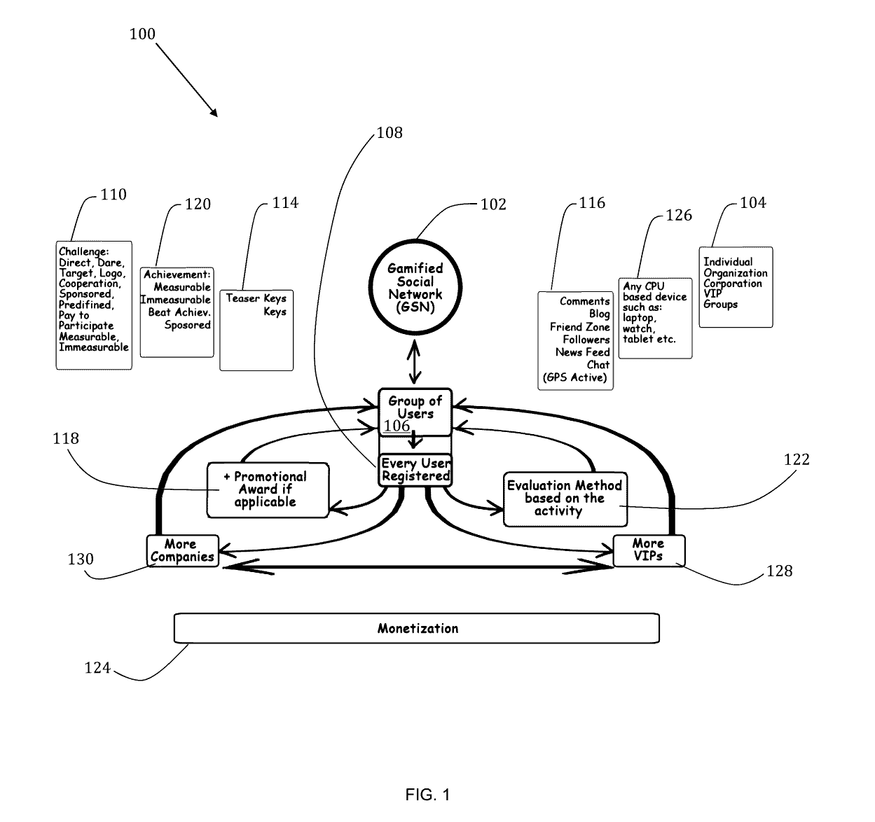

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 100 and method 700 for generating challenges 110 and awarding promotional awards through a gamified network 102 is referenced in FIGS. 1-40. The system 100 and method 700 is configured to gamify a network 102, while also integrating marketing and monetization into the network 102; and especially a social network 102.

In one embodiment, system 100 creates a game through a social network, by providing a challenge 110 with a challenge, and integrating marketing into the creation, participation, and successful completion of the challenge or achievement. The network can be used for any type of challenge, be it sports, education, creativity, lifestyle, etc.

System 100 enables a user 104 or a group 106 in a network 102 to participate in performing the challenge 110, evaluating the challenge 110 or user 104, commenting on the challenge 110 or user 104, and awarding a promotional award 118 based on successful achievement 120 of the challenge 110.

In essence, the system 100 and method 700 gamifies the social network 102 through challenges 110 that require skill and provide entertainment and education, while also monetizing the network 102 through promotional awards and other marketing means known in the art.

FIG. 1 illustrates a block diagram showing one possible embodiment of the system 100 for generating challenges and awarding promotional awards through a gamified network. Shown is the interface between parties with an interest in the system 100, including: general users, advertising companies, organizational users, VIPs, and additional companies that may pay or receive payment to participate in the network 102. Also shown are the types of games and the types of users 104, groups 106, and organizations. The different functions of communication 116, promotional awards 118, and fees 124 are also shown. In essence, FIG. 1 shows how the network 102 is enhanced beyond a standard online community by providing interesting, challenges 110 that can be performed by a user 104 and numerous members 108 of a group 106 who share the same network 102.

In some embodiments, user 104 and group 106 may include, without limitation, consumers, employees, managers, theologians, educators, medical specialists, gadget lovers, socialists, show-offs, and ambitious people. The user 104 may also be any age, gender, or religion in order to participate in the gamified network 102. System 100 is easily downloadable and operable on a functional screen size 126 for a communication 116 device that can be accessed by the user 104 or group members 108.

As FIG. 1 shows, the user 104 or group 106 may accept and participate in the challenge 110, either alone against a program, or against other members 108 of the group 106 in the network 102, or any user 104 in the network 102. The system 100 provides myriad challenges having various nuances for competition and marketing advancement. The challenge 110 requires skill, while also providing entertainment, or educational benefits, or both.

The system 100 enables a user 104 or group 106 in a network 102 to present a challenge 110 to each other. In response to a received challenge 110, the user 104 participates in the challenge 110 alone against a program or other members 108 of the group 106. The user 104 or group 106 may evaluate the performance of the challenge 110, and the performance of other users 104 participating in the challenge 110. The evaluation 122 may be based on measurable units or immeasurable votes from other users 104. The challenge participant may also be required to produce a proof to demonstrate achievement or completion of challenge 110. A scoring system based on points that advance group members to higher levels may be used to evaluate the challenge 110 or user 104.

The user 104 and the group 106 may also comment and share information about the challenge 110 or user 104 performing the challenge 110 or proof of completion of the challenge 110 or achievement 120. This may include approvals, disapprovals, advice, and general chatting. In this manner, users 104 can interact with the group 106 and the network 102 about the challenges 110 or performance of the user 104 or group 106. An activity board, a blog, and a newsfeed also provide real time information about ongoing challenges and status of group members.

After a challenge 110 is accomplished, a promotional award 118 can be awarded to the successful user 104 or group 106. Promotional awards 118 can be awarded to user 104 or group 106 who successfully accomplishes challenge 110, so as to monetize the system 100 and method 700. Promotional award 118 may include awards comprising marketing indicia. Promotional awards 118 serve to market and monetize the system 100. Other monetizing tools may include user fees 124, advertisements, and promotional plans.

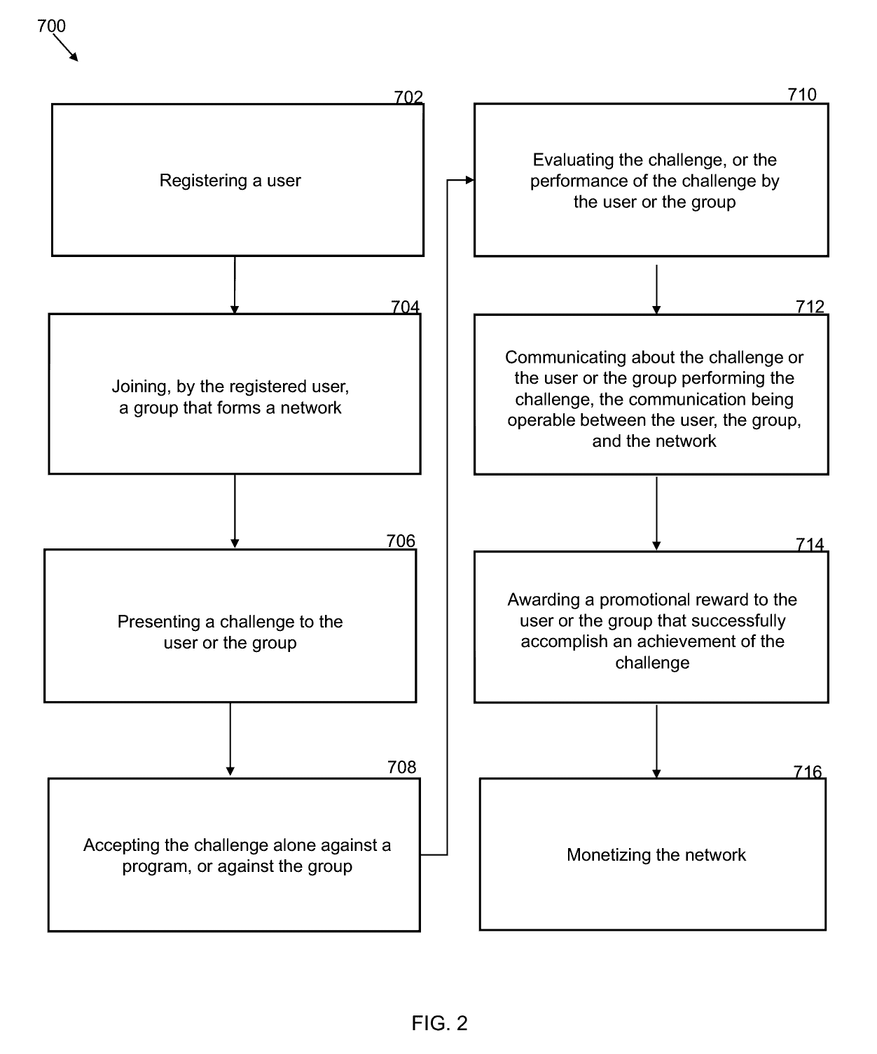

As referenced in the flowchart diagram of FIG. 2, a method 700 for generating challenges and awarding promotional awards through a gamified network comprises an initial Step 702 of registering a user 104. Registration may require the user 104 to provide data, including, without limitation, input personal information, contact information, preferred challenges 110, and consumer history. The registration information determines the user type of the user 104 within the network 102. Once registered as a user 104 with a user type, the registered user 104 may participate in and create challenges 110, create achievement 120, join a group 106, and participate in challenges and activities with other group members 108.

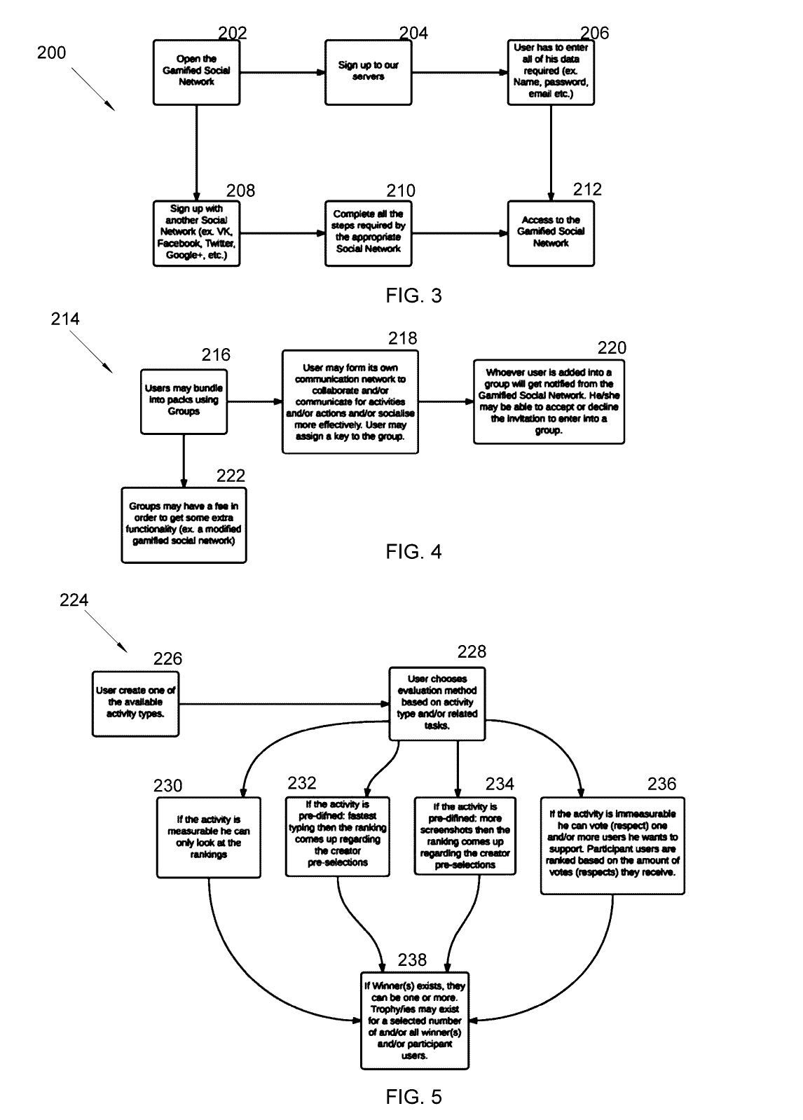

In one possible embodiment of the system 100, a prospective user 104 initially registers an account with the network 102. This registration process 200 is referenced in FIG. 3. In this process 200, a prospective user 104 may register as a regular user 104, a company, an organizational user 130, or a very important person (VIP) 128. VIP are users with a specific number of followers and specific access to their profile and activities. Based on the type of user 104, and demographics of the user 104, the profiles are determined. This is important when determining which user 104 information to publicly display and which actions to make available within the system.

Different types of user accounts will be available. Examples of available user 104 types include regular users 104, organizational users 130, and VIP 128. Based on user type and user demographics, some users 104 may have different details in their profiles and/or data shown. For example, users 104 who have been promoted to VIP and organizational users 130 may differentiate from other users 104 in terms of actions (ex. different type of votes, respects, comments, blogs, and general availability of information). Some or all users 104 may be able to change background on their profiles.

For example, an organizational user 130 may differentiate from other users 104 in terms of actions. Thus, organizational users 130 may have different type of votes, in order to gain respect, and allow for different type of comments, blogs, posts, profile views, and availability of functions, favorites, group 106 settings and the like. Some or all users 104 may be able to change background on their profiles. Furthermore, a user 104 may be promoted within the system 100, for example from regular user 104 to VIP 128, based on their performance or recognition in the network 102. A user 104 may be promoted to VIP status, for example, by obtaining a minimum level of followers.

The registration process 200 may include an initial Step 202 of opening the network. A Step 204 comprises signing up on a server. A Step 206 includes entering, by the user, data such as personal information, password, email, etc. A Step 210 may include completing the steps. A Step 212 comprises signing up with another social network to complete the process 200.

The method 700 may include an additional Step 704 of joining, by the user, a group that forms a network. Network 102 may include, without limitation, a social network, a work-related network, a shopping network, a consumer network, and an educational network. Group members 108 may have like-minded views on a specific subject, or may simply be drawn to a network that provides entertainment.

User 104 joins the group 106 or forms a group that makes up the network 102 in a group joining process 214, illustrated in FIG. 4. In forming a group 106, an initial Step 216 comprises bundling into packs to form the groups. A Step 218 may include a user forming a communication network to collaborate and communicate for activities. In this Step 218, user may also assign a key to the group. A Step 220 requires that whoever is added to a group is notified from the network. The user may then accept or decline the invitation to the group. A Step 222 may allow the group to charge a fee. Group 106 can be formed with all available user account types. Different account types may have different group settings and functionalities. Access to all or some of the activity, as well as action functionalities, may be available. In addition, settings to customize the group 106 page to specific requirements may be offered for some and/or all account types for a fee 124, if the fee is applicable.

The method 700 may further comprise a Step 706 of presenting a challenge to the user or the group. Two primary types of activities are available to user 104: a challenge 110 and upon successful completion of the challenge 110, or post an achievement 120. Furthermore, the user 104 or group members 108 may perform an action. The action is defined as any function available to the user 104 or group 106 in the confines of the network 102, including a comment, a respect function, a like function, a follow function, a nominate function, an evaluate function, blogging, chatting, or forming groups 106. Based on the user's type and user's demographics (e.g. age limitations), some or all of the actions may be available.

In some embodiments, the challenge 110, however, is the essence of the gamification. The challenge 110 may be predefined by the software, or created by a user 104 or group 106. Challenge 110 may include an activity or achievement related activity involving multiple group members 108. User 104 or group 106 may select from a number of available challenge types or a combined number of challenge 110 types. However, dependent on the user type and demographics of the user 104. There may be limitations on available challenges.

Method 700 provides various types of challenges 110 to create greater interest in the gamification. The challenges 110 are segregated into a measurable challenge and an immeasurable challenge. The measurable challenge is based on quantifiable activities where performance can be measured such as a typing-themed game or a screen shot identification-themed game or any quantifiable activity (sport-themed activities, high score-themed activities, etc.) and may include without limitation: a direct challenge, a logo challenge, a sponsored challenge, a cooperation challenge, a target challenge, a pay to participate challenge, a money reward challenge; a prize reward challenge, a sponsored challenge, a dare challenge, and a predefined challenge. The immeasurable challenge is based on group member opinions, and may include, without limitation: a direct challenge, a logo challenge, a sponsored challenge, a cooperation challenge, a target challenge, a pay to participate challenge, a money reward challenge; a prize reward challenge, a sponsored challenge, a dare challenge, and a predefined challenge.

A Step 708 comprises accepting the challenge 110 alone against a program, or against the group 106 or against any user 104. User 104 has the option of accepting or rejecting the challenge 110. User 104 may also request a different challenge. User 104 or group member 108 may prefer some challenges 110 to others. Also, the user 104 or group member 108 may not have time to perform the challenge 110. Thus, the option to decline the challenge 110 without giving a reason is available.

A Step 710 includes evaluating the challenge, or the performance of the challenge by the user or the group. While performing the challenge 110, the user 104 or group members 108 or the program may evaluate the user or group member 108 or challenge 110 through various functions and communicate the evaluation 122. One form is a vote function and a respect function for immeasurable activities, or for automatic measurable or pre-defined activities by the system 100.

FIG. 5 illustrates a process 224 for evaluation of the user, group member, challenge or achievement. The evaluation may be performed through various means by the user 104 or group members 108 or an algorithm. The evaluation 122 may include vote functions and respect functions for immeasurable activities, or automatically by the system 100 for measurable or pre-defined activities. An algorithm creates evaluation 122 rankings based on the user 104 and group member evaluation 122. The rankings help the user 104 achieve a level within the network 102.

The process for evaluation 224 comprises an initial Step 226 of the user creating a user type based on the user's personal information and demographics. A Step 228 allows user to choose an evaluation method based on the type of challenge presented for evaluation. If the challenge is measurable, Step 230 allows the user to only view the rankings. If the challenge is predefined, such as in Fast Typing challenge, a Step 232 allows for the rankings to display in accordance with challenge creator pre-selections.

However, if the challenge is predefined, such as in More Screenshots challenge, a Step 234 allows for the rankings to display in accordance with challenge creator pre-selections. If the challenge is immeasurable, a Step 236 allows the user to vote or respect a group member. A Step 238 provides promotional award to the winner of the challenge, or to a selected number of winners, or to all participants. The promotional award may include a trophy having advertising media on it.

A Step 712 may include communicating about the challenge or the user or the group performing the challenge, the communication being operable between the user, the group, and the network. The communication 116 can occur through various means known in the art, including, without limitation, comments, chat functions, like functions, respect function, blogs, and news feeds.

In one example of communication 116, the user 104 or group 106 may receive notifications through email or text that relate to updates on actions and activities that affect them. In communicating, the user 104 or group 106 may also socialize through blogs and chat rooms or groups 106. A comment plug-in may also be used to help connect the user 104 with the group 106, such that friendships and associations can form therebetween. Furthermore, status updates and new feeds about user 104 or group 106 interests may also be announced and shared.

In one embodiment of the communication 116, the user 104 or group 106 shows approval for a group 106, challenge 110, achievement 120, or activity through multiple channels. User 104 or group 106 may select a desired action or manner of performing the challenge 110. The communication 116 helps to gamify the challenge 110, and thereby the network 102.

In some embodiments, user 104 or group 106 may indicate approval with a respect function, which is similar to a like action or a vote action. The respect action indicates approval or support for a challenge 110, achievement 120, action, user 104, or group 106 that is performing the challenge 110. In another form of communication 116, the user 104 or group 106 can nominate each other for a challenge 110 based on certain characteristics or qualities of the nominee. User 104 or group 106 may also nominate others outside the network 102 in other networks, including potential members 108 and users 104.

Another means for communicating between user 104 and group 106 is on an activity board. The user 104 and group members 108 may receive notifications and updates on challenges 110 and achievements 120 that are related or unrelated to them on the activity board. The activity board sends notifications to a communication device of the user 104, which is accessible from within the network 102 and the communication device's prime software, or SMS, or email function.

In some embodiments, user 104 may socialize posting on a personal blog or a blog of a group member 108. The blog may be a regular updated page run by the user 104 or group member 108 for posting formal news and having informal or conversational style discussions about the challenge 110, achievement 120, or activities in the network 102. The blog may include, without limitation text, photo, video, data, and files.

Another means for communicating between user 104 and group 106 is through a chat function. The chat function may be used with a software application, messages, voice, and emails. The chat enables the user 104 and group 106 to communicate in real time. In one embodiment, the chat may be GPS-active and the user 104 may be able to see other users 104 in a certain range having enabled this function. The user 104 or group 106 may also exchange any kind of media through the chat, including, without limitation, text, photo, video, and file.

In yet another form of communication 116, the user 104 or group 106 may use a comment plug-in to comment within the network 102 or other sites using their registered account. User 104 or group member 108 may be able to comment on the challenge 110 or achievement 120 or both. User 104 or group 106 may also comment on friend's profiles, and followers' profiles, and profiles of users they follow, and other groups. The comments can consist of text, photo, video, data, and files. The user 104 may also respect a comment or reply to a comment.

In yet another form of communication 116, the user 104 or group 106 may be able to request friends in the network 102 through a friend function. User 104 or group 106 simply direct the friend function to a desired member 108. In the friend feature, a user 104 and group member 108 must consent to the friendship. The selected friends receive updates on the other user 104 actions on news feed, activity board, blog, comments, and chats between user 104 and group members 108. In other embodiment of communication 116, the user 104 and group member 108 may also follow and have followers through use of a follow function. The followed user 104 or member 108 may receive updates on the registered entity's actions. Users 104 may also follow other users 104, challenges 110, and achievements 120.

In yet another form of communication 116, user 104 and group 106 have access to a news feed screen. Through the news feed screen, the user 104 remains updated on group members 108, challenges 110, achievements 120, news, and advertisements provided on a regular basis for companies, VIP's, followed users 104, friends, and group members 108.

In yet another form of communication 116, the user 104 and group 106 may utilize a favorite function to indicate a primary preference for one or more group member 108, challenge 110, or achievement 120. The favorite function may be shown on the user 104 profile and may be publicly available or available to a limited number of group members 108.

In yet another form of communication 116, the user 104 and group 106 may perform a respect function directed to members 108 of the group 106, thereby showing approval of the group member 108, challenge 110, or achievement 120. The respect function is similar to a like function or a vote function, in that it allows the user 104 or group members 108 to show their support and preference for the group member 108, challenge 110, or achievement 120.

In yet another form of communication 116, the user 104 and group 106 may nominate each other to perform a challenge 110 or activity. In nominating, some of or all other users 104, dependent on user 104 type and demographic, can participate in a challenge 110, even if not directly challenged by a user 104 or group member 108.

In yet another form of communication 116, the system 100 may enable the user 104 or group 106 to share information regarding their profiles, challenges 110, achievements 120 in or out of the network 102. Using a key function, users 104 can share the challenge 110 or activity. In some embodiments, the system 100 may also have a search feature, where a user 104 can search for other users 104, group members 108, challenges 110, and achievements 120.

In some embodiments, a Step 714 comprises awarding a promotional award to the user 104 or the group 106 that successfully accomplish an achievement 120 or a challenge 110, the promotional award 110 comprising a marketing indicia. The promotional award 118 is configured to provide the dual function of indicating success of the user 104 or group 106, and promoting a product or service. In this manner, monetization of the method 700 is possible. The types of achievements 120 that warrant a promotional award 118 may include, without limitation, a measurable achievement 120, an immeasurable achievement 120, a beat achievement 120 function, and a sponsored achievement 120.

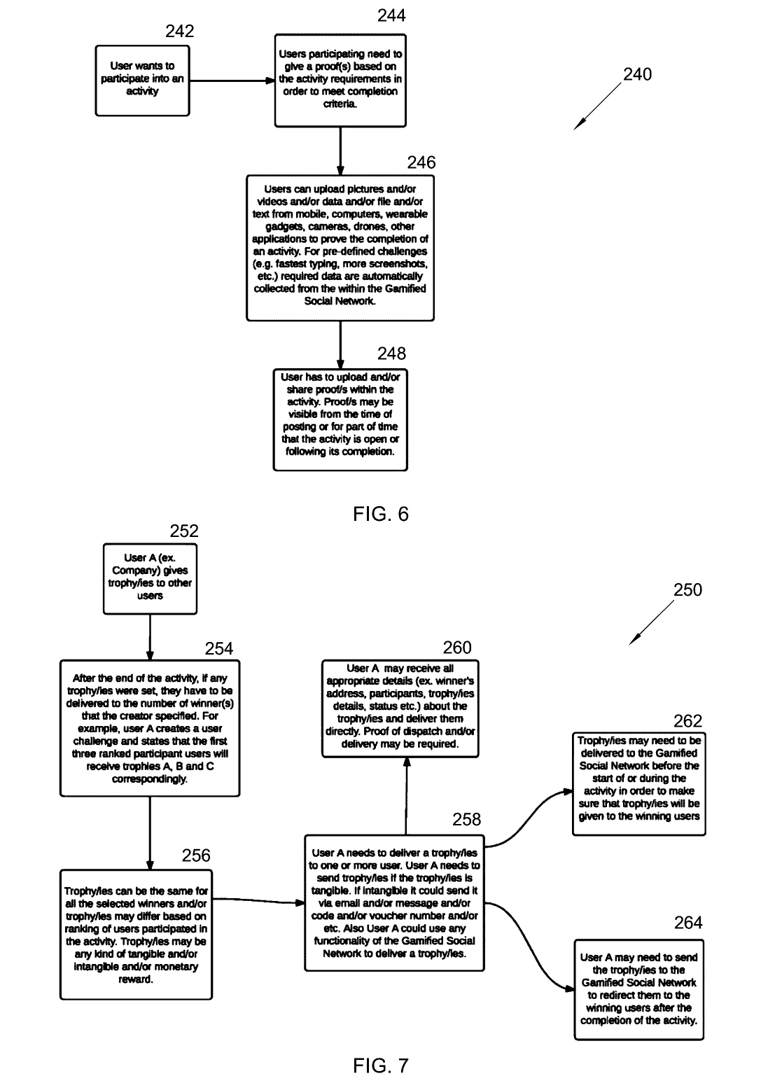

The completion and result of an activity may be demonstrated by a process 240 for producing proof, as shown in FIG. 6. In this manner, there is evidence that the user 104 or group member 108 completed the challenge 110 or the achievement 120. The proof process 240 comprises an initial Step 242 of the user wanting to participate in a challenge. A Step 244 allows the user to provide tangible proof that the challenge was completed or achieved based on challenge requirements.

In some embodiments, the proof process 240 further includes a Step 246 that comprises the user uploading images, videos, files, or text from a mobile communication device, such as a smart phone or gadgets. However, for predefined challenges, such as Fast Typing challenge, the data from the challenge is automatically uploaded.

The winner of an activity, be it a challenge 110 or an achievement 120, may receive a promotional award, such as a trophy or medal, which may be in tangible, intangible, or monetary form. FIG. 7 illustrates a process 250 for providing the promotional award 118 in the form of a trophy. An initial Step 252 comprises User A giving a trophy to another user. A Step 254 then provides that after the end of the challenge, if any trophies were set, they have to be delivered to the winners of the respective challenges, according to the number of winners that the challenge creator or sponsor specified.

Next, a Step 256 teaches that the trophies can be the same for all the winners, or the trophies can be different based on the rankings of the user or group member participating in the challenge. The trophies may be any kind of tangible, intangible, or monetary type. At Step 258, User A, sponsor or the network delivers the trophies to the winners. If the trophy is tangible, User A physically delivers the trophy. If the trophy is intangible the trophy is sent through various means, including, without limitation, email, text, message, voucher number, and bank wire transfer.

To ensure that the trophy is sent to the appropriate winner, a Step 260 provides that User A may receive all appropriate details of the winner, such as address, participants, and the trophy details. A proof of delivery may be required. A Step 262 requires the trophies are delivered to the network for distribution. A Step 264 requires User A to send the trophies to the network or redirect the trophies to the winner after completion of the challenge.

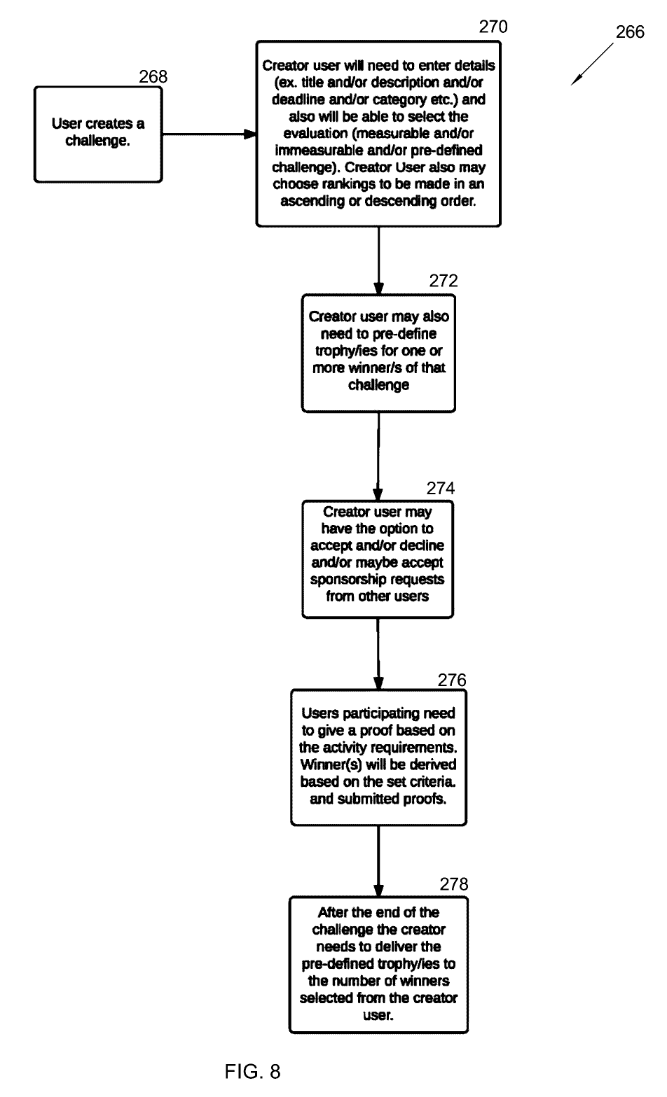

FIG. 8 shows a process 266 for creating a user challenge. In a user challenge, the user 104, group 106, company, or VIP may provide the promotional award 118, such as the trophy process 250 shown in FIG. 7, to a number of winning users or group of its own choice. The creator may then display advertising material throughout the challenge page. The registered entity may have the option to promote the challenge within/outside the system 100 of the present disclosure. In this embodiment, costs to the customer may incur, which helps monetize the network 102.

The user challenge is a unique challenge in that it allows one user to create a challenge, and challenge another user or another member of the group, or vice versa. The process 266 for creating the user challenge includes an initial Step 268 of the user creating the challenge. The creator may imagine a challenge or borrow ideas when creating the challenge. A Step 270 may include the user providing details about the challenge, such as steps of how the challenge operates. The creator may also select an evaluation, and whether it is based on a measurable, immeasurable, or predefined challenge. The creator may also choose rankings in ascending or descending order.

A Step 272 comprises the creator predefining the promotional awards, such as trophies for the winners. A Step 274 comprises the creator having the option to accept or decline sponsorship requests for the user challenge. A Step 276 requires that participants of the user challenge provide a proof that the challenge was completed based on activity requirements. A Step 278 teaches that after the end of the user challenge, User A delivers the promotional awards to the winners, based on the number of winners designated.

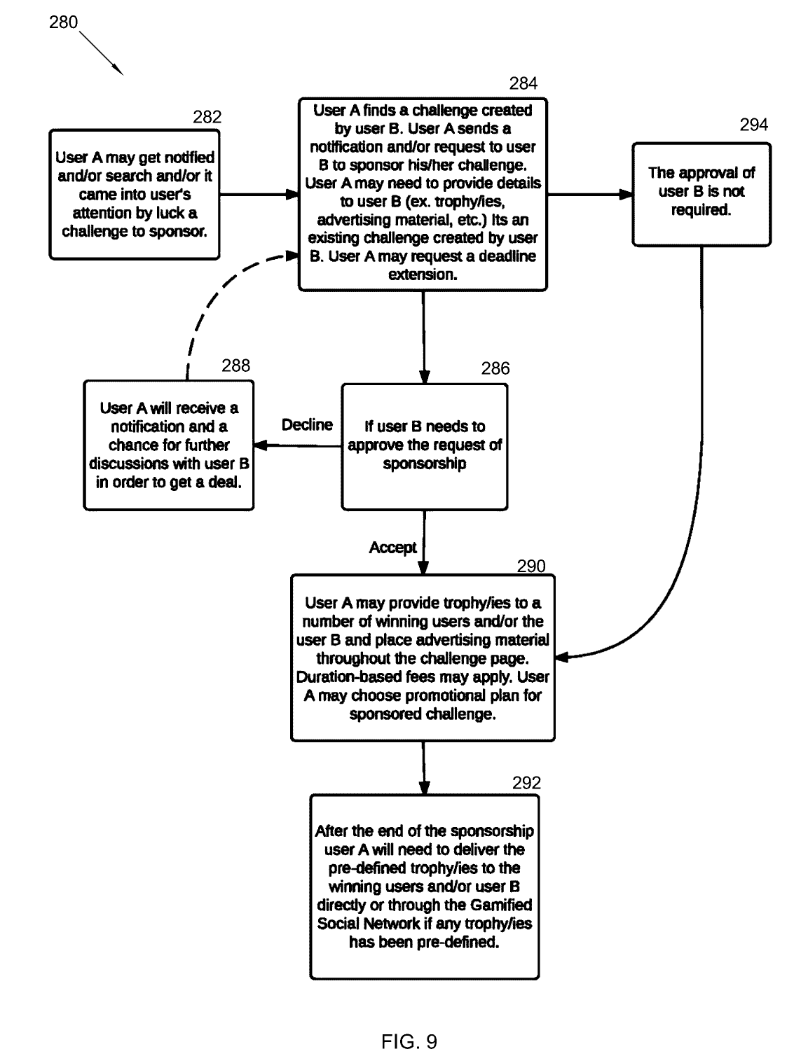

FIG. 9 shows an exemplary process 280 for creating a sponsored challenge 110, where a registered user 104 can choose to sponsor an existing challenge 110. That is, the entity may provide the promotional award 118 to a number of winning users 104 of its own choice and the creator or the network may place advertising material throughout a challenge page to be viewed and interacted with by participants of the challenge. The approval of the creator may be required. The registered entity may have the option to extend the deadline for a maximum number of days. The registered entity may have the option to promote the challenge 110 within/outside the network 102 based on creator(s)-registered entity agreement.

The process 280 for creating a sponsored challenge 110 comprises an initial Step of User A finding or getting notified for a challenge to sponsor. A Step 284 may then include User A finding a challenge that is created by a User B. User A then sends the notification to User B, indicating a desire to sponsor the challenge. If in a Step 294, the approval of User B is not required, User A proceeds to Step 290 of providing promotional awards to winners of the sponsored challenge, and affixing promotions on the promotional awards, such as trophies.

A Step 286 requires User A to receive approval from User B to use the challenge. A Step 288 indicates that after declined approval, User A receives a notification and a chance for further discussions with User B. However, if User B agrees, Step 290 enables User A to provide promotional awards to winners of the sponsored challenge, and affixing promotions on the promotional awards, such as trophies. A final Step 292 teaches that after the end of the sponsorship, User A delivers the predefined trophies to the winners and User B directly or through the network.

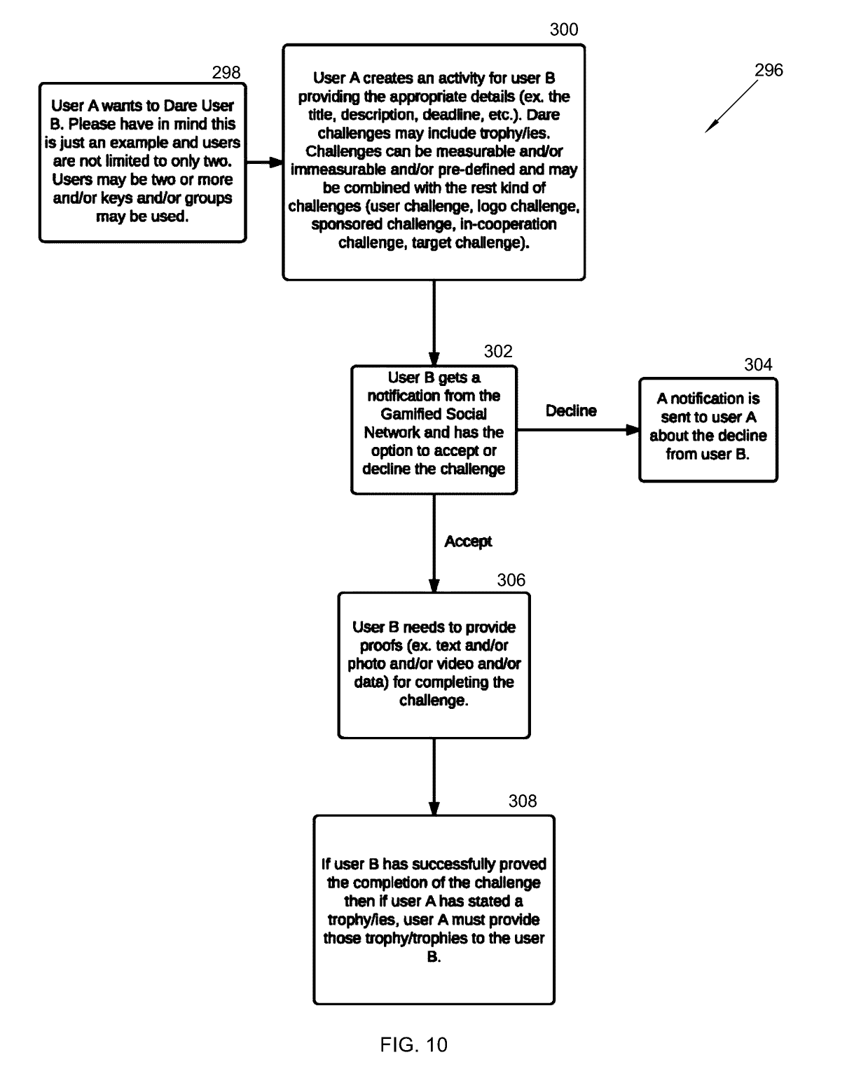

FIG. 10 shows a process 296 for producing a dare challenge 110, where the user 104 may have the option to directly challenge 110 another user 104(s) by asking the latter party to complete an assigned task with the option of offering a trophy upon completion. The process 296 includes an initial Step 298 of User A wanting to dare User B to a challenge. This may be a mere thought. A Step 300 requires User A to create a challenge for User B, while providing the appropriate details of the challenge, such as title, deadline, description, etc.

In some embodiments, a Step 302 comprises User B receiving notification from the network about the challenge created by User A. If User B declines the challenge, a Step 304 provides that a notification is sent to User A indicating the decline. If User B accepts the challenge, a Step 306 requires User B to present proof in the form of images, text, files, or videos, indicating completion of the challenge. After User B successfully completes the challenge, a Step 308 requires User A to provide the promotional award, such as a trophy, to User B.

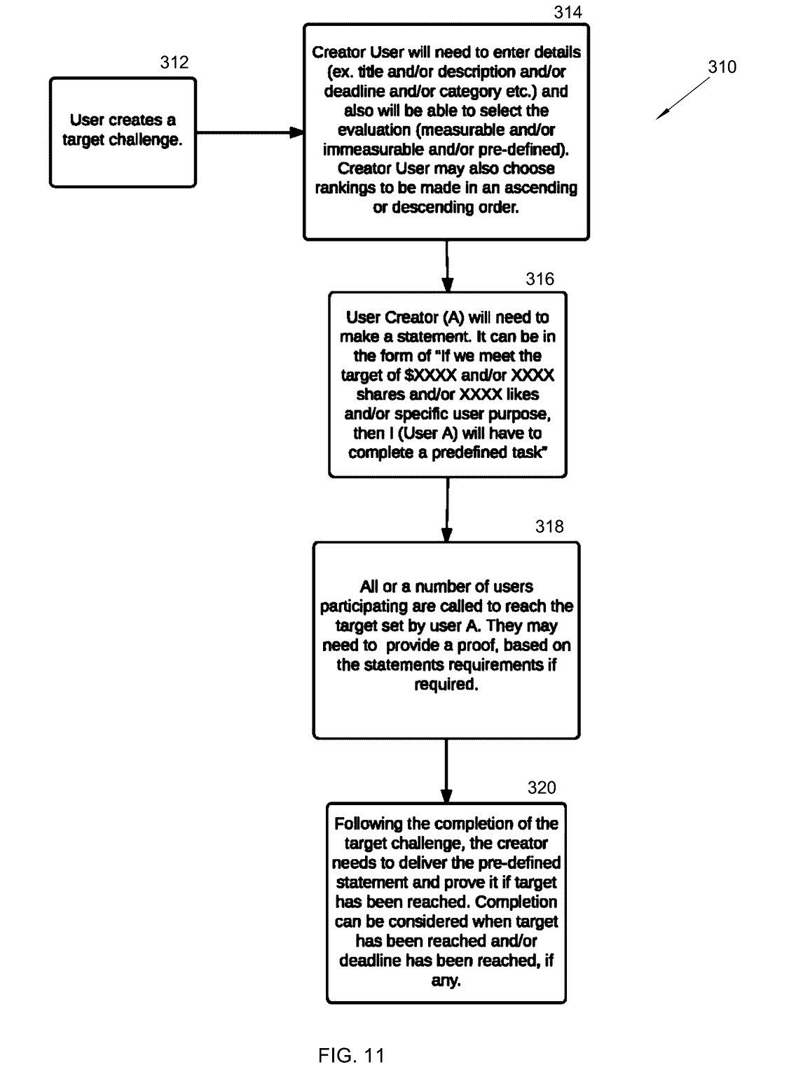

FIG. 11 shows a process 310 for creating a target challenge. The target challenge enables a user 104 to endorse a challenge, where the user commits to complete a task if the target set by the creator of the challenge 110 is met. The process 310 includes an initial Step 312 of a creator producing a challenge. A Step 314 provides that the creator provides details about the challenge, such as steps of how the challenge operates, deadlines, and whether the challenge is measurable, immeasurable, or predefined.

In some embodiments, a Step 316 allows User A to provide a conditional statement indicating the details of the challenge. An exemplary statement may include, “If we meet the target of [$XX] and [XX] shares and [XX] likes and a specific user purpose, then I (User A) will complete a predefined task”. After this conditional statement, a Step 318 requires the participants in the challenge to achieve the stated criteria. Following completion of the target challenge, a Step 320 provides that User A delivers the promotional award, such as a trophy, to the participants who achieved the target or completes the predefined task.

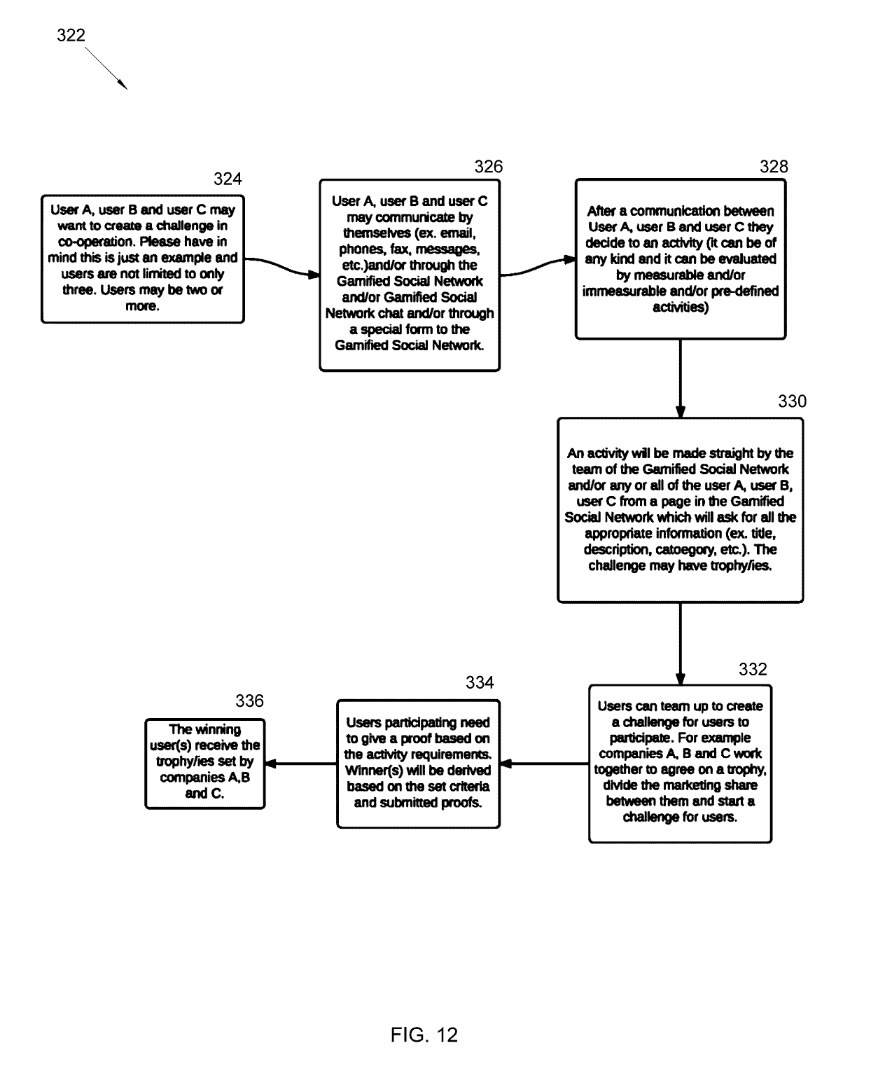

FIG. 12 shows a process 322 for creating a cooperation challenge 110. The cooperation challenge enables users 104 to team up to create a challenge 110. Users 104 can be of the same user type, different user type, and group 106. The cooperation challenge process 322 comprises an initial Step 324 of a User A, a User B, and a User C wanting to create a challenge in cooperation with each other. Though in other embodiments, two users or more may cooperate for these means. In a Step 326, User A, User B, and User C communicate internally through known communication means, email, phone, the network, etc.

After communicating between User A, User B, and User C, a Step 328 requires the Users to decide to an activity, including the challenge. The challenge may be immeasurable, measurable, or predefined. A Step 330 provides that the network will create the challenge after collecting details about the challenge form User A, User B, and User C. A Step 332 allows User A, User B, and User C to team up to select participants in the challenge. For example, companies A, B, and C work together to agree on a promotional award, such as a trophy. The companies may then divide the marketing share between themselves and find participants for the challenge. A Step 334 provides that participants in the cooperation challenge provide proof to completing the challenge under the set conditions. A Step 336 provides that the winning participants receive the promotional award set by companies A, B, and C.

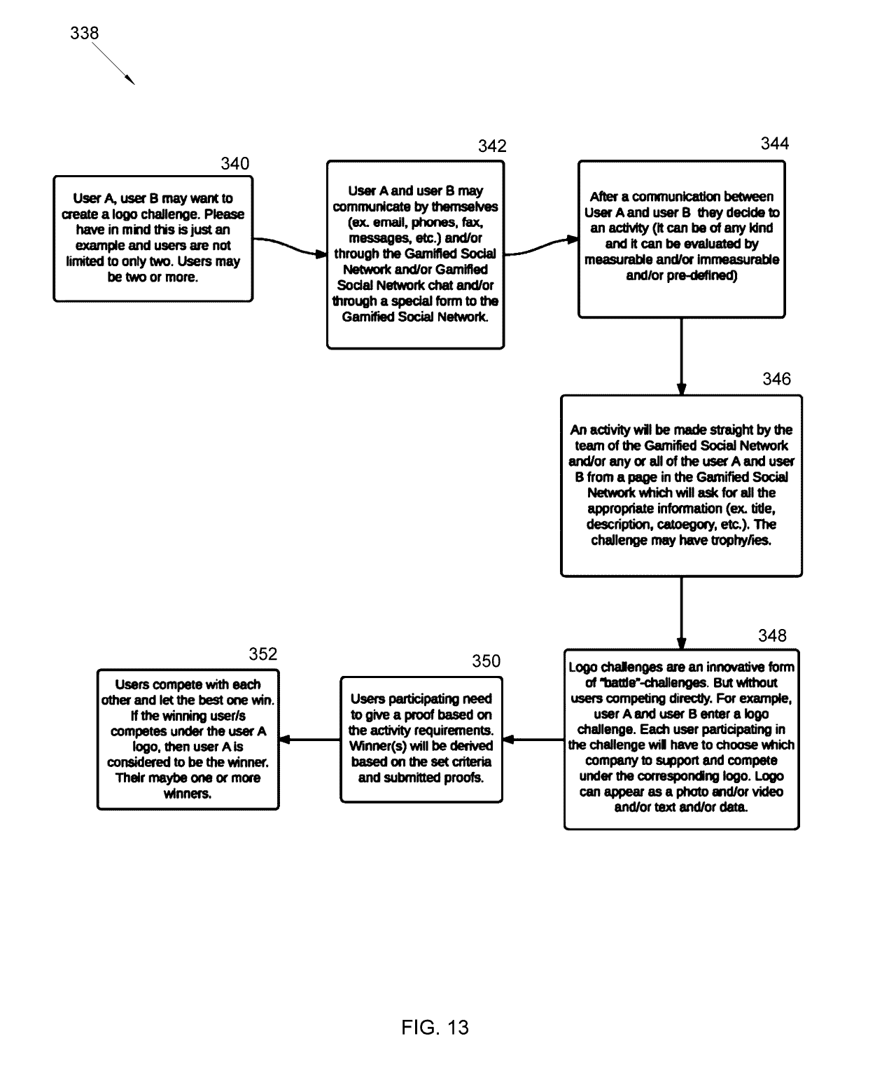

FIG. 13 shows a process 338 for creating a logo challenge 110. The logo challenge provides an innovative form of battle themed challenges with participant users competing under one of the creators' logo. In this version of challenges, users 104 must be two or more and may be of the same user type, different user type, and group 106.

The logo challenge process 338 comprises an initial Step 340 of User A and User B wanting to create a logo challenge. A Step 342 may include User A and User B communicating internally through known communication means, email, phone, network, etc. After communication, a Step 344 requires the Users to decide to an activity, including the challenge. The challenge may be immeasurable, measurable, or predefined. A Step 346 may include the network creating a challenge based on descriptions and information provided by User A and User B.

A Step 348 comprises participants performing the logo challenge. The logo challenge is a unique battle themed challenge, but without participants battling directly against each other. For example, User A and User B enter a logo challenge. Each user participating in the challenge must choose which company to support and compete under the corresponding logo. The logo may appear as a photo, video, text, or data. A Step 350 enables the participating users to provide proof to completing the challenge under the set conditions. In a final Step 352, participating users compete to arrive at a winner. If the winning user competes under the User A logo, then User A is the winner. Though, there may be more than one winner.

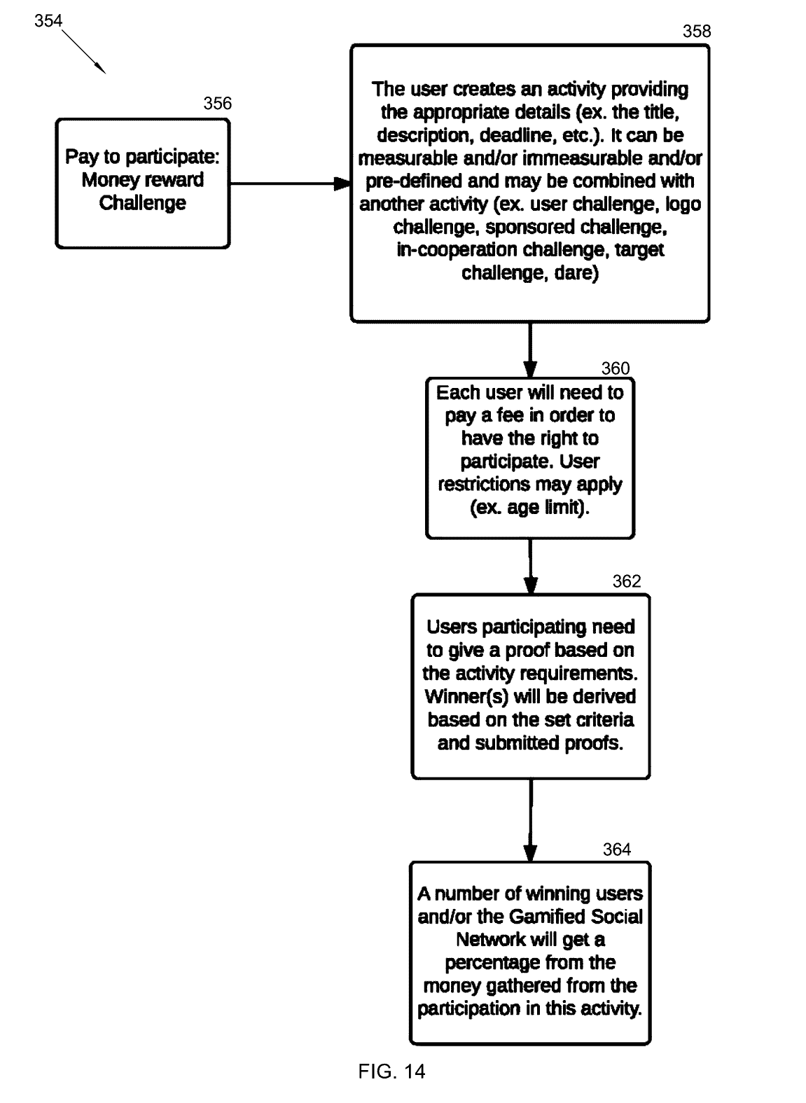

FIG. 14 shows a process 354 for creating a pay to participate money reward challenge. In the pay to participate challenge, the user 104 pays a fee 124 to participate in the challenge. Limitations on participant criteria may apply. A selected number of winning users, participant users, challenge creator, and the network may receive a percentage from participation fees.

The process 354 includes an initial Step 356 of a creator deciding to create a pay to participate money reward challenge. A Step 358 allows the creator to create a challenge and provide the appropriate details for performing the challenge. The pay to participate challenge may be combined with other challenges, including, without limitation, a measurable challenge, an immeasurable challenge, a sponsored challenge, a cooperation challenge, and a dare challenge.

A Step 360 comprises the user participants paying a fee to participate. The creator may apply restrictions to which user is eligible to participate. A Step 362 enables the participating users to provide proof to completing the challenge under the set conditions. A Step 364 allows the participation fees to be divided between the network and the winners of the challenge in the form of money.

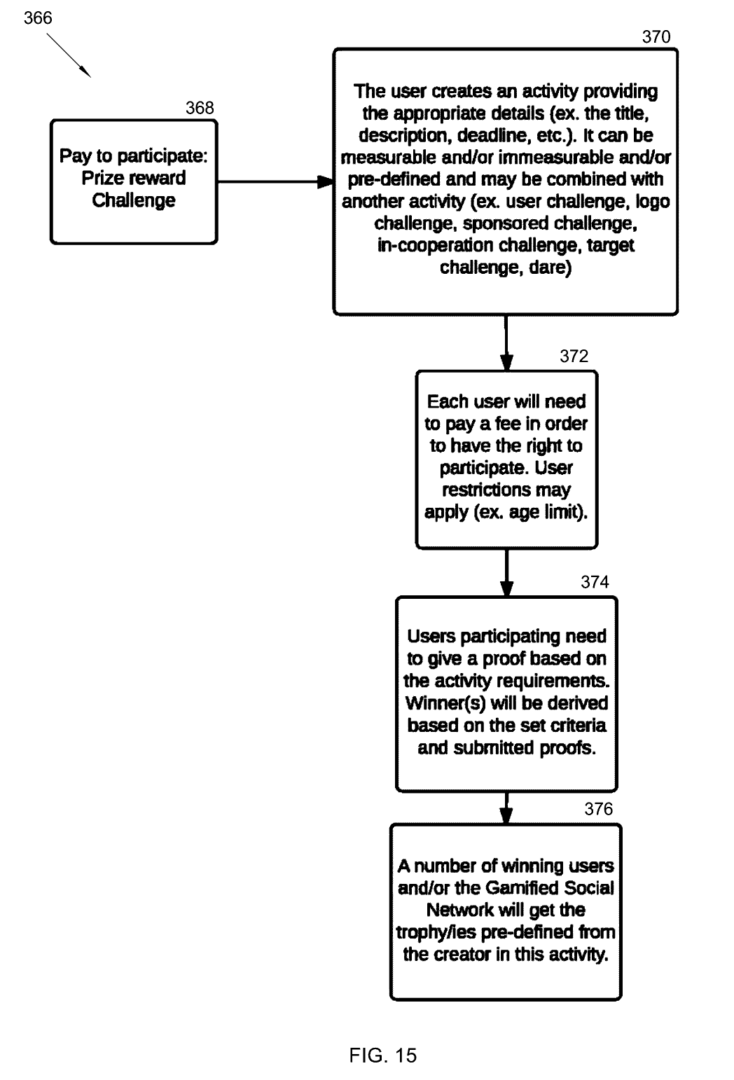

FIG. 15 illustrates a process 366 for paying to participate in a prize reward challenge 110. In this unique challenge, the user 104 pays a fee 124 to have the right to participate. In some embodiments, limitations on participant criteria may apply. A selected number of winning users 104 and/or participant users 104 will get the trophy pre-defined from the creator of this activity. Participation fees 124 will be appropriated to at least one of the following: the creator, the network 102, and third parties.

The process 366 includes an initial Step 368 of a creator deciding to create a pay to participate prize reward challenge. A Step 370 allows the creator to create a challenge and provide the appropriate details for performing the challenge. The pay to participate challenge may be combined with other challenges, including, without limitation, a measurable challenge, an immeasurable challenge, a sponsored challenge, a cooperation challenge, and a dare challenge.

A Step 372 comprises the user participants paying a fee to participate. The creator may apply restrictions to which user is eligible to participate. A Step 374 enables the participating users to provide proof to completing the challenge under the set conditions. A Step 376 allows the reward to be divided between the network and the winners of the challenge in the form of a prize, such as a trophy or medal or part of the participation fees.

The method 700 may further include a Step 716 of monetizing the network 102. In some embodiments, the method 700 may implement additional marketing tools, beyond the promotional award, including: charging users and groups a fee, charging a sponsor an advertising fees, promotional fees, and user and group members purchasing virtual products or services while performing the challenge. And, as discussed above, the promotional award 118 contains marketing indicia which also monetizes the network 102.

In one embodiment, an advertising marketing tool enables the user 104 or group 106 to pay a fee 124 for advertising on the network 102. The advertising material may include, without limitation, logos, coupons, maps, photos, videos, posts, data, links re-directing inside and/or outside the network 102.

In some embodiments, an alternative Step may include providing a proof that the challenge 110 has been completed or successfully accomplished with a proof. The completion and result of an activity task may be demonstrated by proof. The winner of the challenge 110 may receive a trophy or reward, which may be in tangible, intangible, or in monetary form. The completion and result of an activity task may be demonstrated by proof. The proof may include images, videos or data of the challenge 110 being performed or accomplished. Another alternative Step comprises setting privacy parameters by the user 104 or the group 106. Privacy settings and file sharing are also variable options.

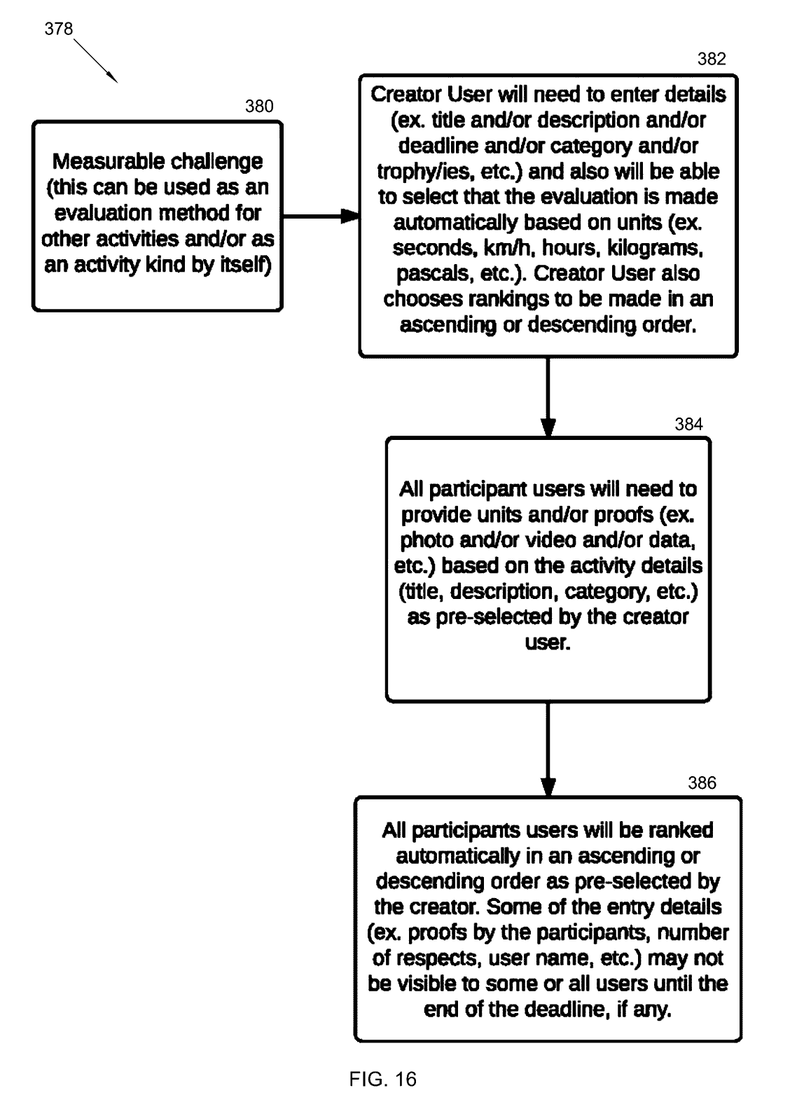

In one embodiment of the present disclosure there are two ways to evaluate the challenge 110. The first is a measurable challenge 110, as shown in FIG. 16. In a measurable challenge 110, the user 104 creates a measurable challenge 110 by selecting an evaluation 122 method 700 based on units.

A process 378 for evaluating the measurable challenge includes an initial Step 380 of taking a measurable challenge. The measurable challenge is a challenge that can be quantified. Examples are a fast typing challenge or any quantifiable activity related challenges (sport-themed challenges, high score-themed challenges, etc.). A subsequent Step 382 may include a creator entering details of the measurable challenge, including title, descriptive rules, category of the challenge, deadline to finish the challenge, and promotional awards provided for achievement of the challenge. A Step 384 enables the participating users to provide proof to completing the challenge under the set conditions. A Step 386 ranks all participants in an ascending or descending order as predefined by the creator of the measurable challenge.

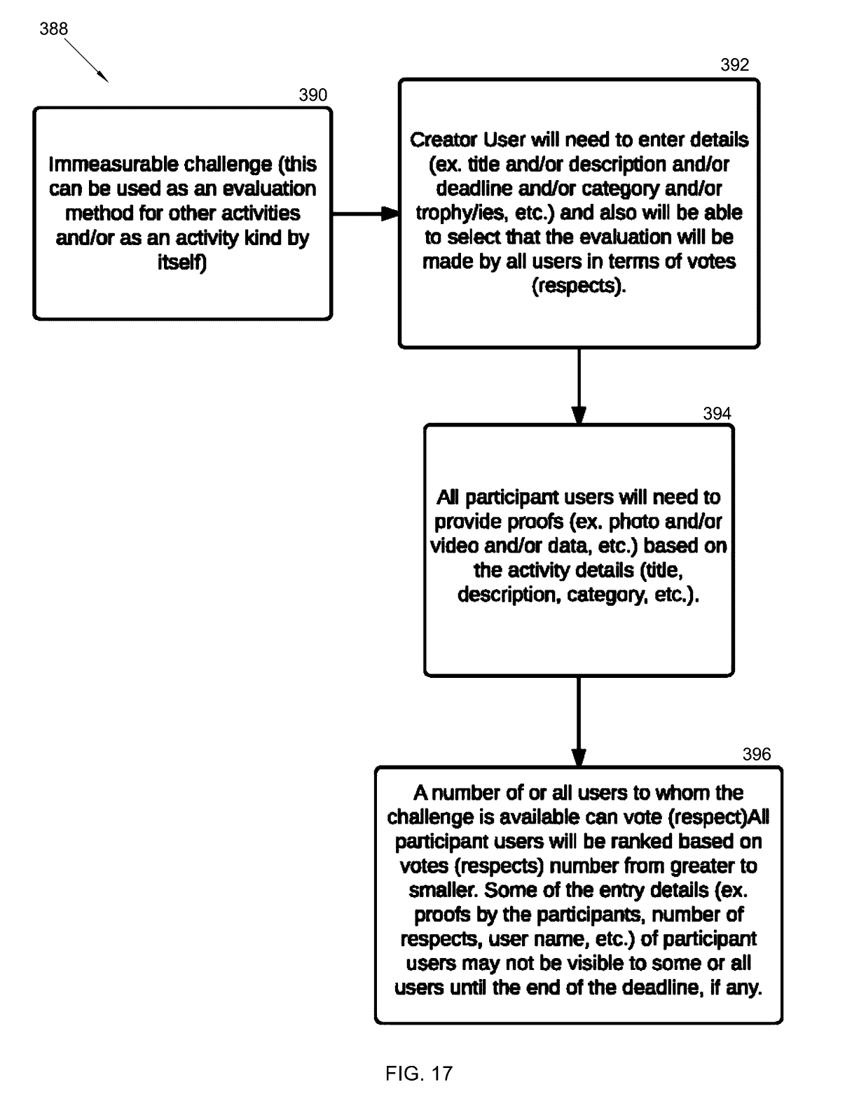

FIG. 17 illustrates how a challenge 110 may be evaluated through an immeasurable challenge 110. In the immeasurable challenge 110, the user 104 selects an evaluation 122 means based on the number of votes, or respects, or comments, or all that have accumulated.

Rather than create a challenge 110 for users 104 to participate, a user 104 may select a predefined challenge 110. Here, a user 104 creates a predefined challenge 110 for any number of users 104 and group members 108. User 104 has to choose one of the available pre-defined tasks offered by the network 102 or other third party software. These tasks may include shapes, numbers, words, images, and video related tests and games.

Examples of such tasks may be used to test multiple skills using a variety of tests, such as IQ tests, crossword puzzles, calculations, and the like. The evaluation 122 method 700 of predefined challenges 110 is preset based on the nature of the task and measurement may be taken and recorded through the network 102 or with the aid of various devices.

A process 388 for evaluating the immeasurable challenge includes an initial Step 390 of taking an immeasurable challenge. The immeasurable challenge refers to activities that cannot be quantified and it is a vote-based challenge. A subsequent Step 392 may include a creator entering details of the immeasurable challenge, including title, descriptive rules, category of the challenge, deadline to finish the challenge, and promotional awards provided for achievement of the challenge. A Step 394 enables the participating users to provide proof to completing the immeasurable challenge under the set conditions. A Step 396 ranks all participants in an ascending or descending order as predefined by the creator of the immeasurable challenge.

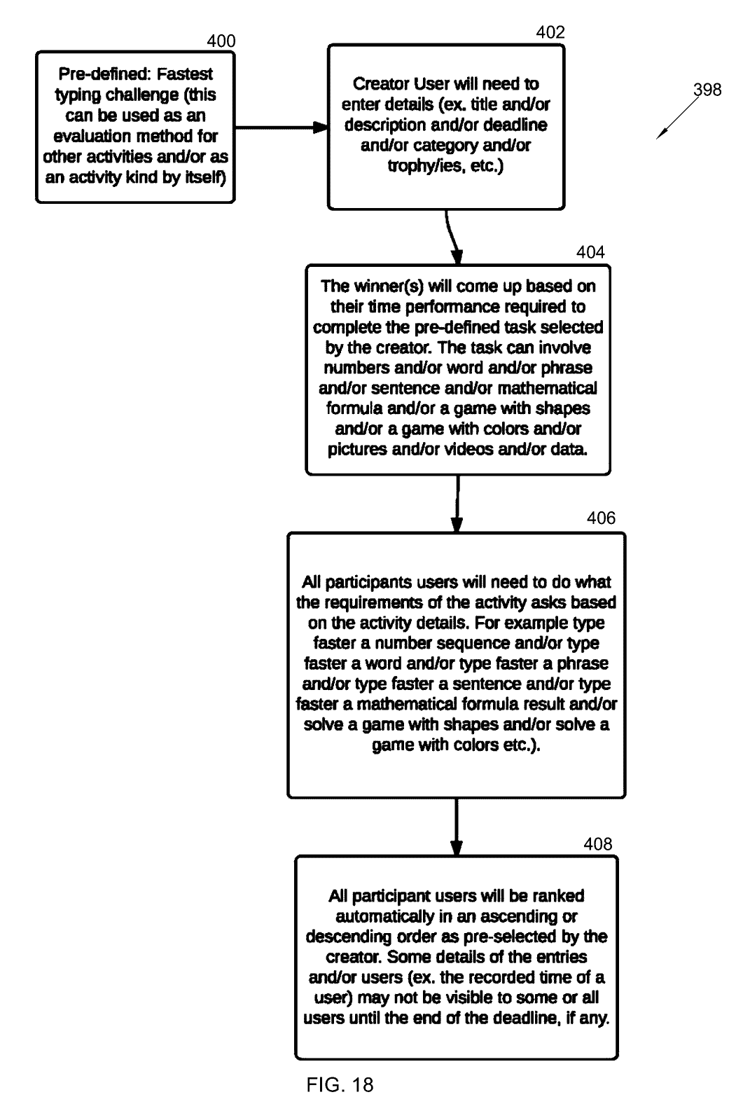

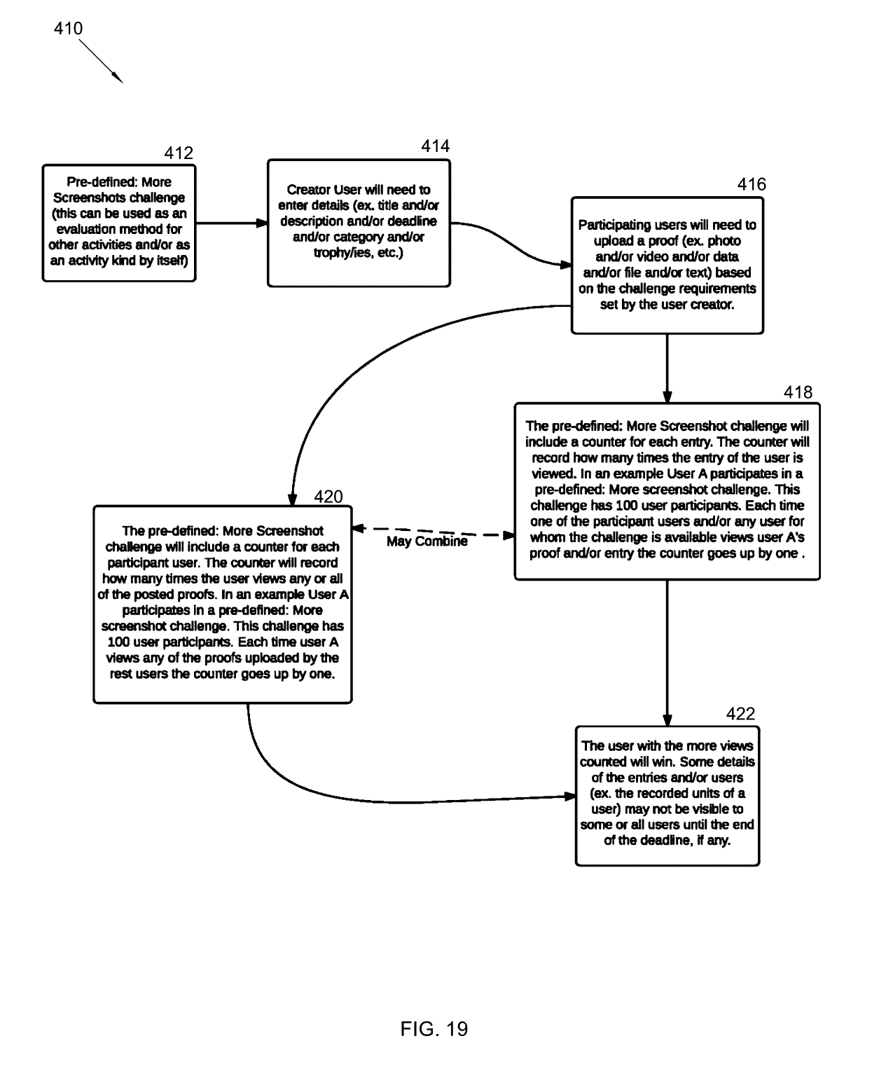

FIGS. 18 and 19 illustrate two exemplary of pre-defined challenges. A Fastest Typing, shown in FIG. 18, enables users 104 to select whether to create a predefined: Fastest Typing challenge 110 and winner based on which the user 104 or group members 108 complete a task in the fastest time such as typing, solving puzzles, mathematical problems, etc.

A process 398 for providing the predefined challenge of the Fastest Typing challenge. The Fastest Typing challenge includes an initial Step 400 of accepting and performing the Fastest Typing challenge. The Fastest Typing challenge is a challenge that can be quantified, since the rate of typing and the words per minute are countable. A subsequent Step 402 may include a creator entering details of the Fast Typing challenge, including title, descriptive rules, category of the challenge, deadline to finish the challenge, and promotional awards provided for achievement of the challenge.

A Step 404 provides a winner based on a timed performance required to type letters, numbers or patterns. For example, the user is asked to quickly type a sequence of letters or phrases or numbers or mathematical formula. In Step 406, the participant users are required to perform the task in the predefined format. A Step 408 ranks all participants in an ascending or descending order as predefined by the creator of the measurable challenge.

In the More Screenshots challenge, shown in FIG. 19, the user 104 or group members 108 may select to create a predefined challenge 110. The winner of the More Screenshots challenge 110 is determined on views of screenshots, photos, videos, data, or combinations thereof.

A process 410 for providing the predefined challenge of the More Screenshots challenge. The More Screenshots challenge includes an initial Step 412 of accepting and performing the More Screenshots challenge. The More Screenshots challenge is a challenge that can be quantified, since the screenshots are countable. A subsequent Step 414 may include a creator entering details of the More Screenshots challenge, including title, descriptive rules, category of the challenge, deadline to finish the challenge, and promotional awards provided for achievement of the challenge.

A Step 416 requires participants to upload a proof based on the More Screenshots challenge requirements. A Step 418 provides a More Screenshots challenge that includes a counter for each entry. The counter records how many times the entry of the user is viewed. In an example, User A participates in the More Screenshots challenge with one hundred other participants. Each time one of the participant users views user A's proof or entry, the counter increases one unit for User A. In another embodiment of More Screenshots challenge, a Step 420 each time User A views another participant's proof, User A's counter increases by one unit. In a final Step 422, the participant with the highest counter wins the More Screenshots challenge.

The second type of activity that occurs is the achievement 120. The achievement 120 indicates successful completion of a task. With an achievement 120, there is no direct contest between users 104, rather, the purpose of the achievement 120 is to achieve a goal or a level of ability. User 104 creates an achievement 120 and makes it available for viewing by group 106 or network. User 104 can select from different types of achievements 120 or a combined number of achievement types. Based on user type and user demographics, user 104 may have limited options on available achievement types.

Once the user 104 chooses an achievement 120 the following list of options will appear for the user 104 to fill appropriate data, such as the name of the achievement 120, description (written and in video type, photo or data), categories, deadline, evaluation method, value of personal entry if measurable, proof, beat achievement option, preference and/or code for button/link within the challenge 110, in-app purchases, promotion plans, payment details, where appropriate.

Not all listed details may be required; any subset of the listed details may also apply. For example, different types of achievements 120 may require different data fields to be completed and/or some fields may not be available for certain user 104 types and/or some fields may be optional.

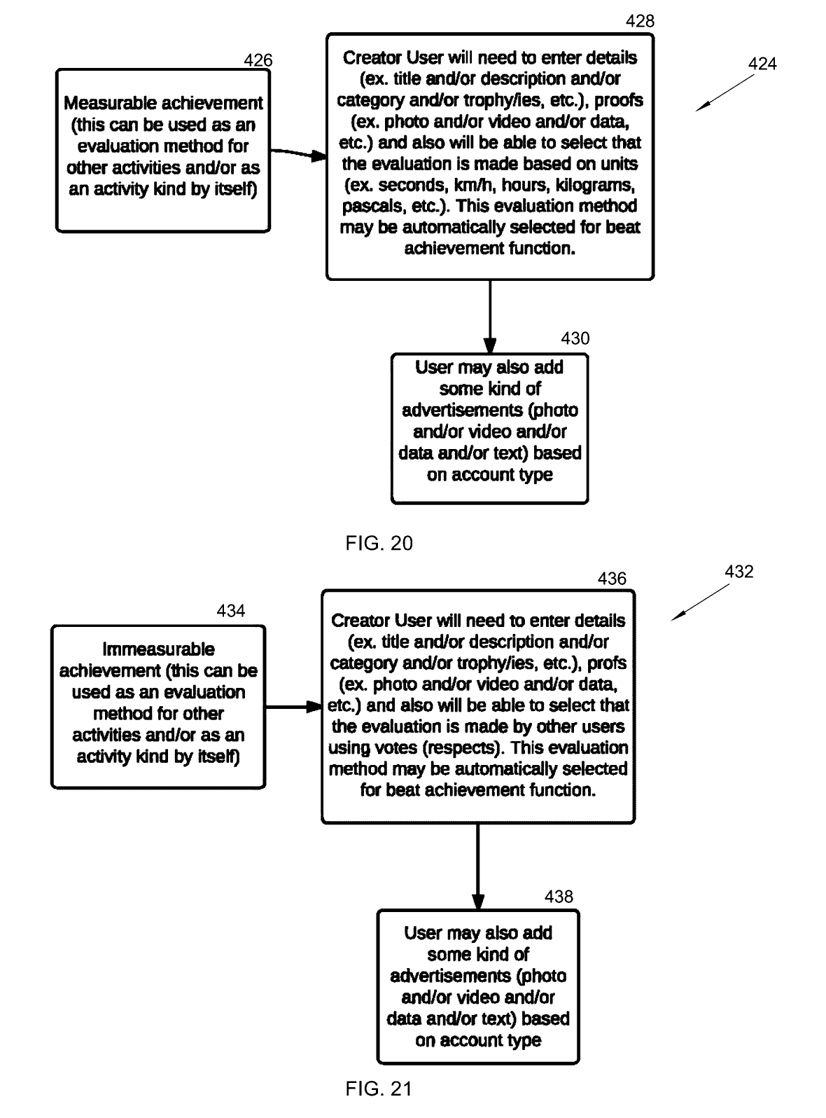

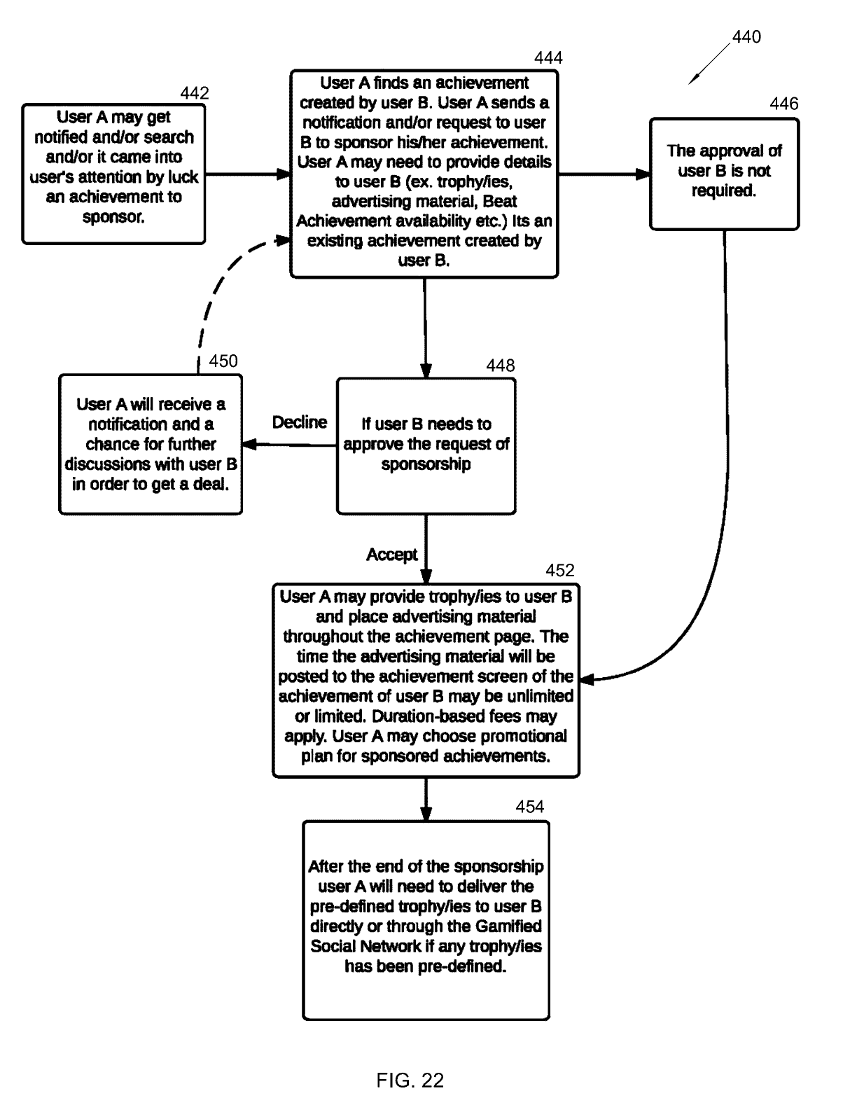

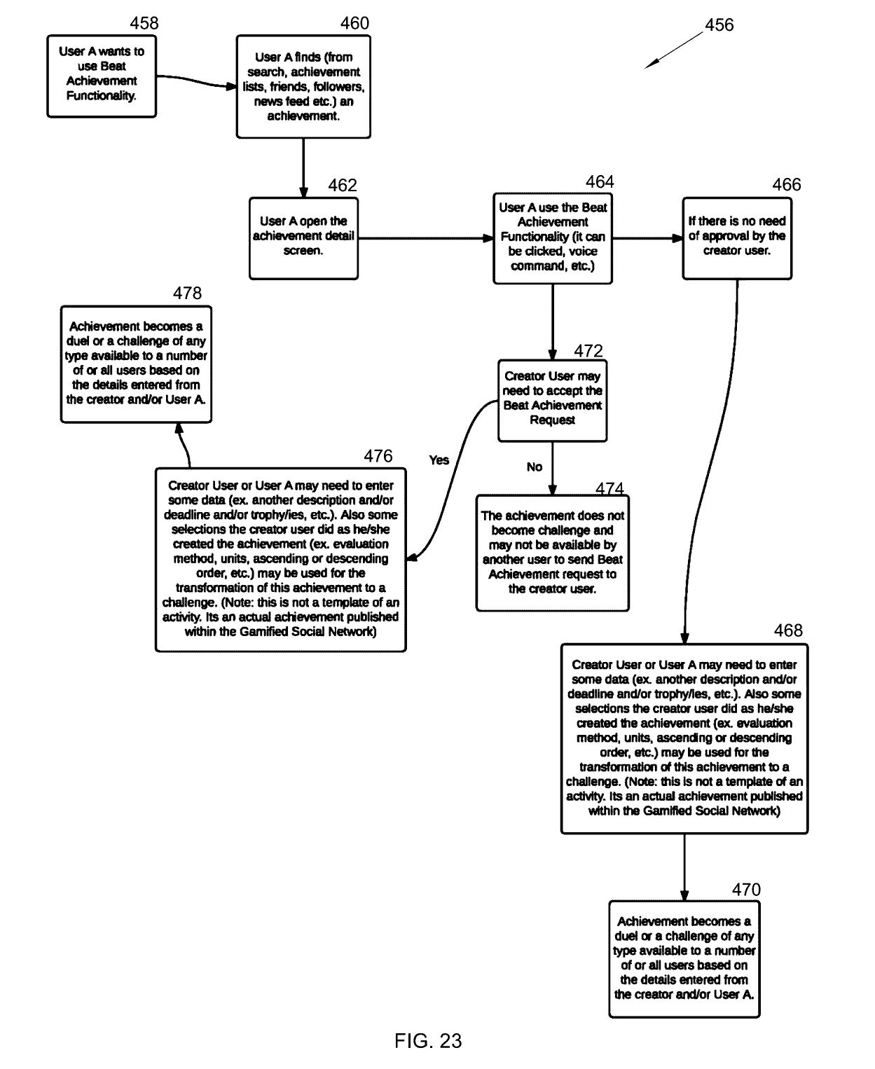

Just as there are two types of evaluations 122 in the preferred embodiment of the present disclosure, there are also two types of achievements 120: a measurable achievement 120, as shown in FIG. 20, and an immeasurable achievement 120, as shown in FIG. 21. Additionally, there is a sponsored achievement 120, as shown in FIG. 22, and a beat achievement 120, shown in FIG. 23.

A process 424 for evaluating measurable achievements includes an initial Step 426 of posting or viewing a measurable achievement. In a Step 428, creator enters the details of the measurable achievement, including title, descriptive rules, category of the achievement, and promotional awards provided for achievement. User also enters proofs. In a Step 430, user may add marketing indicia to advertise a business. This can include a logo, text, images, and videos.

A process 432 for evaluating immeasurable achievements includes an initial Step 434 of posting or viewing an immeasurable achievement. In a Step 436, creator enters the details of the immeasurable achievement, including title, descriptive rules, category of the achievement, and promotional awards provided for achievement. User also enters proofs. In a Step 438, user may add marketing indicia to advertise a business. This can include a logo, text, images, and videos.

In a sponsored achievement 120, a registered user 104 can choose to sponsor an existing achievement 120. That is, the entity may provide trophy to the creator and/or place advertising material throughout the achievement 120 page. The approval of the achievement 120 creator may be required based on creator's settings. The registered entity may have the option to promote the achievement 120 within or outside the network 102 based on the user 104 or group 106 registered entity agreement. Costs may incur during sponsoring.

A process 440 for performing a sponsored achievement includes an initial Step 442 of User A finding or getting notified for a challenge to sponsor. In Step 444, User A finds an achievement of User B. User A then sends a notification to User B to sponsor the achievement. A Step 446 assumes the approval of User B is not required. If so, a Step 452 allows User A to provide a promotional award 118 to User B. However, in Step 448, if User B needs to approve the request for sponsorship. A Step 450 requires User A to receive notification to discuss further with User B.

A Step 452 requires User A to place marketing indicia on the promotional awards. The time the marketing indicia is posted to an achievement screen, User B may be unlimited or limited. Duration-based fees may apply. User A may choose promotional plan for sponsored achievements. A Step 454 requires that after the end of the sponsorship, User A delivers the promotional awards to User B directly or through the network.

In a beat achievement 120, the user 104 enables the beat achievement 120 function. Based on user 104 preferences, a posted achievement 120 of the user 104 can be challenged by other users 104 through the beat achievement process. The activity then becomes a duel, or a challenge 110 of any type available to a number of or all users 104 and group 106.

A process 456 for performing a beat achievement includes an initial Step 458 of a User A wanting to use beat achievement functionality. In Step 460, User A finds an achievement of friends, followers, news feed, etc. In Step 462, User A opens the achievement screen. In Step 464, User A uses the beat achievement functionality. It can be clicked, voice command, etc. A Step 466 assumes the approval of creator user is not required. If so, a Step 468 allows User A enter data or description. Also some selections the creator user did while creating the achievement. In Step 470 beat achievement becomes a dual or challenge of any type available to any user to partake in.

A Step 472 requires User A to accept the beat achievement request. If User A does not accept, A Step 474 requires that the achievement does not become a challenge and may not be available by another user to send the beat achievement request to the creator. If User A does accept, A Step 476 allows User A enter data or description. Also some selections the creator user did while creating the achievement. In a Step 478, achievement becomes a dual or challenge of any type available to any user to partake in.

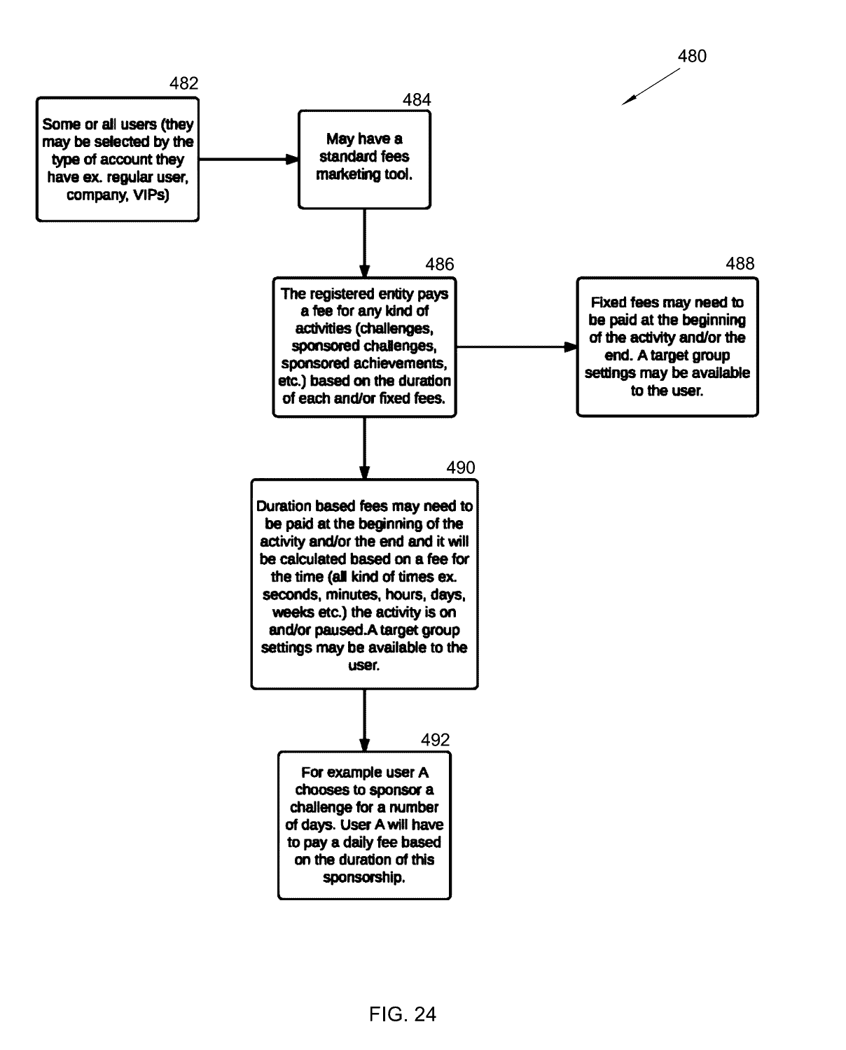

FIG. 24 illustrates an exemplary process 480 for collecting fees 124 for the system 100 and method 700. Some or all users 104 may be selected based on the type of user 104 to pay the fee 124 to create a challenge 110. These fees 124 may be duration-based or fixed. Target group setting will be available and user 104 may be granted the right to post promotional material on the corresponding activity page. The system 100 allows for the implementation of various marketing tools known in the art to monetize by charging fees 124 to generate profit. These include standard fees 124, advertising fees 124, and promotional plans.

Process 480 may include an initial Step 482 of some or all users being selected by their type of account they have, i.e., regular user, VIP, organizational user. A Step 484 requires users to maybe pay a standard fee as a marketing tool. A Step 486 requires registered entities to pay a fee for any kind of activity based on the duration of the activity and the fixed fees.

A Step 488 applies to fixed fees and requires that the fixed fees be paid at the beginning of the activity or the end of the activity. A target group activity may be available to the user for the fixed fee. A Step 490 is for duration fees, and requires that the duration fees be paid at the beginning of the activity or the end of the activity. The duration fee is calculated based on a fee for time the activity is ongoing. A target group activity may be available to the user for the duration fee.

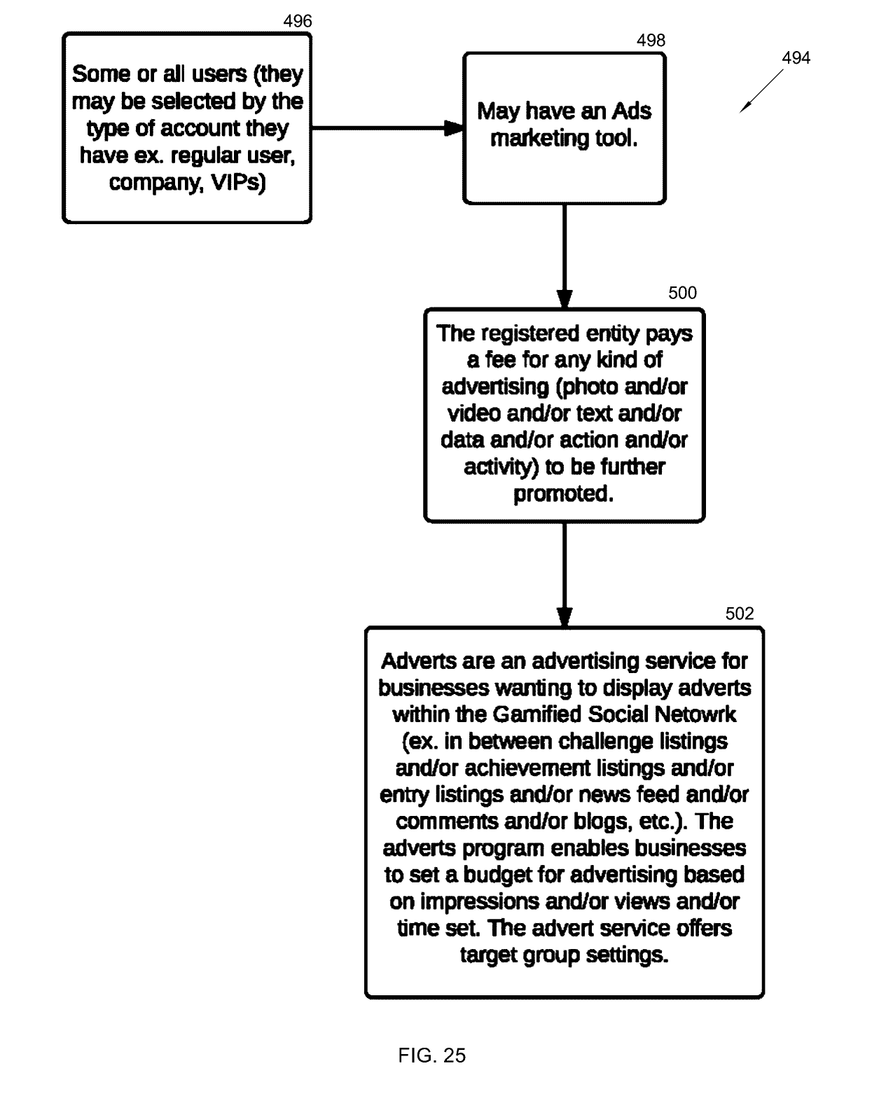

FIG. 25 illustrates a process 494 for achieving an advertising marketing tool. The advertising marketing tool enables the user 104 or group 106 to pay a fee 124 for advertising on the network 102. The advertising material may include, without limitation, logos, coupons, maps, photos, videos, posts, data, links re-directing inside and/or outside the network 102.

A process 494 may include an initial Step 496 of some or all users being selected by their type of account the have, i.e., regular user, VIP, organizational user. A Step 498 provides an advertising marketing tool. A Step 500 requires registered entities to pay a fee for any kind for additional promotion. A Step 502 provides adverts. Adverts are advertising services for businesses wanting to display adverts within the network. The adverts program enables businesses to set a budget for advertising based on impressions and views and time set. The advert services offers target group settings.

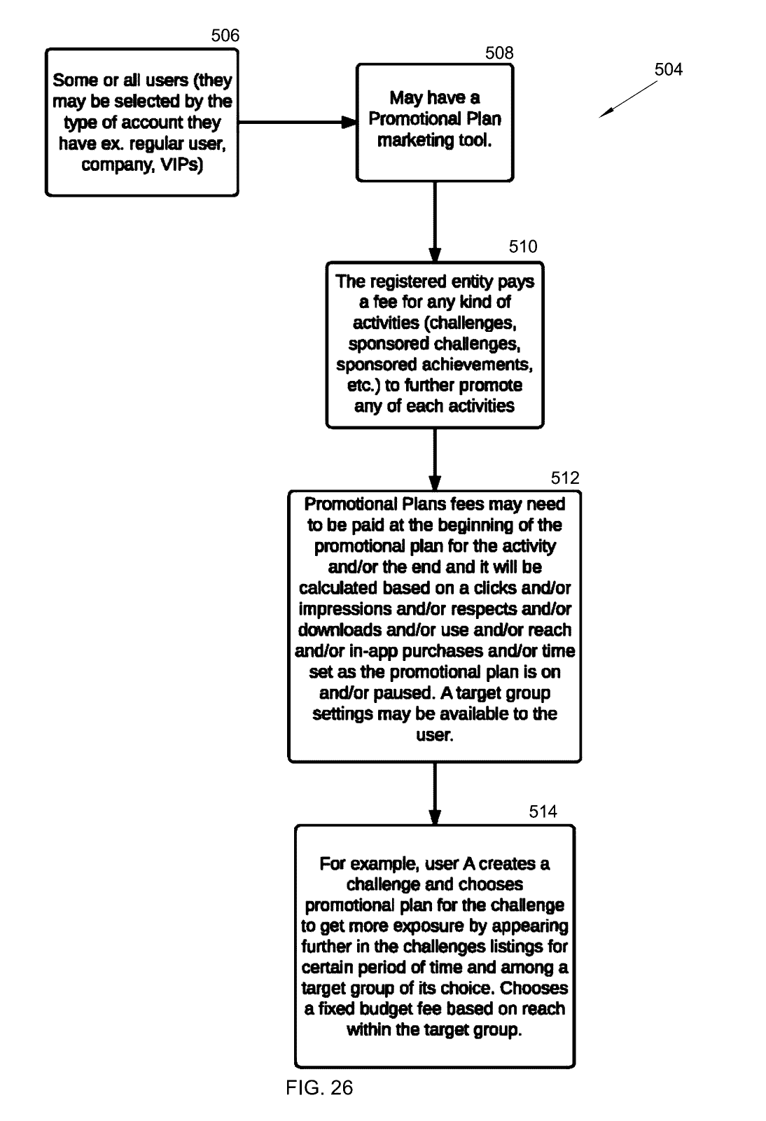

FIG. 26 illustrates a process 504 for achieving a promotional plan. The user 104 and the group 106 may choose to promote the challenge 110, sponsored challenge 110, sponsored achievements 120, etc, with a promotion known in the art.

The process 504 includes an initial Step 506 of some or all users being selected by their type of account they have, i.e., regular user, VIP, organizational user. A Step 508 provides a promotional plan marketing tool. In a Step 510, registered entities pay a fee for any kind for additional promotion. For Step 512, promotional plans fees are paid at the beginning of the activity or the end of the activity. The promotional plans fees are based on click or impression or respect or download or use or reach or in-app purchase or time set as the promotional plan is on or paused. A target group activity may be available to the user for the promotional plan fee.

A Step 514 presents an example where User A creates a challenge and chooses a promotional plan for the challenge to get more exposure by appearing further in the challenges listing for certain periods of time and among a target group of its choices. User A chooses a fixed or cumulative budget fee based on reach within the target group.

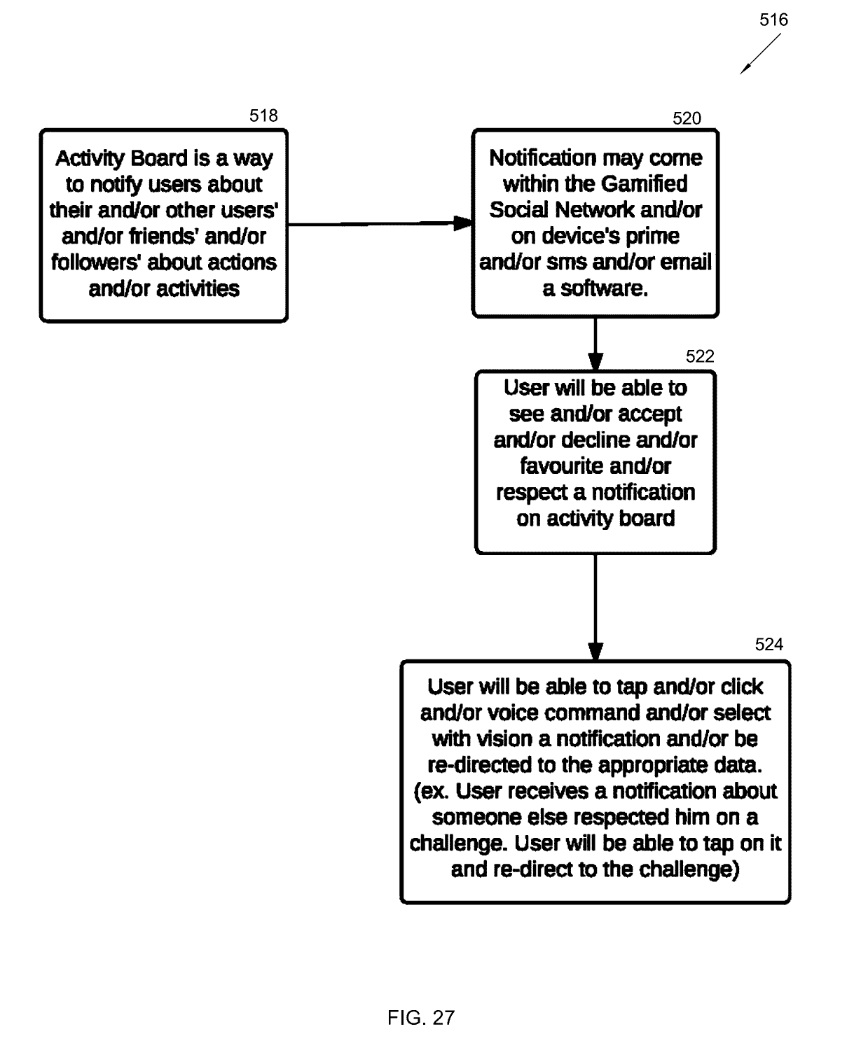

FIG. 27 illustrates a process 516 for notifying through an activity board. The user 104 and group members 108 may receive notifications and updates on challenges 110 and achievements that are related or unrelated to them on the activity board. The activity board sends notifications to a communication device of the user 104, which is accessible from within the network 102 and the communication device's prime software, or SMS, or email function.

Process 516 includes an initial Step 518 of providing an activity board. Activity board is a means to notify users and group about other users, friends, or followers about their challenges and achievements. A Step 520 notifies the user through the network with user's communication device by email, text, or message. In Step 522, user can view and accept or decline notification form the activity board. A Step 524 enables user to tap, click, voice command, or visually select a notification, or be redirected to the appropriate data.

In some embodiments, the users 104 post comments or news on a personal blog or a blog of a group member 108. The blog may be a regular updated page run by the user 104 or group member 108 for posting formal news, and posting informal or conversational style discussions about the challenge 110, achievement 120, or activities in the network 102. The blog may include, without limitation text, photo, video, data, and files.

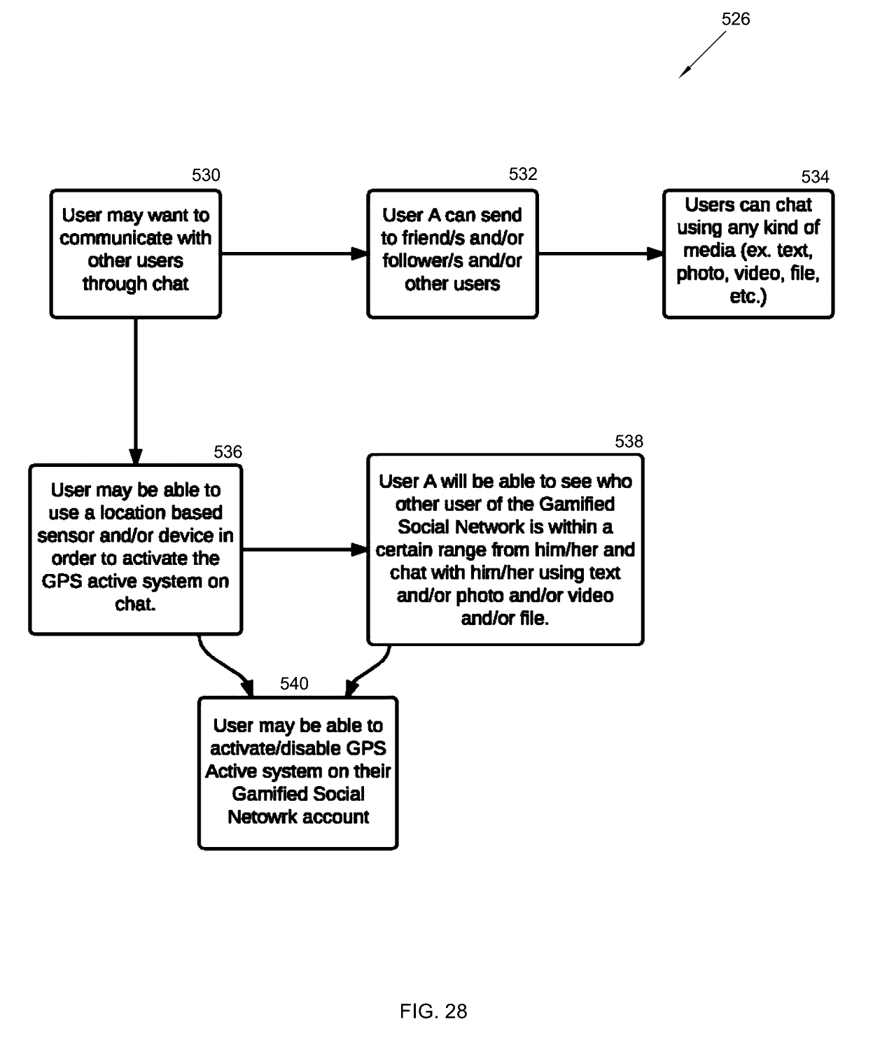

As referenced in FIG. 28, the system 100 provides a process 526 for the user 104 and the group members 108 to communicate with group members 108 through a chat function. The chat function may be used within the software application with messages, with voice, and with emails. In one embodiment, the chat may be GPS-active and the user 104 may be able to see other users 104 in a certain range having enabled this function. The user 104 or group 106 may also exchange any kind of media through the chat, including, without limitation, text, photo, video, and file.

Process 526 includes an initial Step 530 of the user wanting to communicate with other users and group members through a chat function. In Step 532, user can send a chat message to friends, followers, and other users. A Step 534 includes users chatting through various media, including, text, photo, video, file, etc. A Step 536 provides the option of the user using a location based sensor to produce a global positioning system for the chat. A Step 538 allows user to see who others in the network are chatting with within a predetermined range. A Step 540 comprises the user activating or deactivating the positioning system on the network.

In one embodiment of the present disclosure, the user 104 or group 106 may use a comment plug-in to comment within the network 102 or other sites using their registered account. The user 104 or group member 108 may be able to comment on the challenge 110 or achievement 120 or both. The user 104 or group 106 may also comment on friend's profiles, and followers' profiles, and profiles of users 104 they follow, and other groups 106. Comments can consist of text, photo, video, data, and files. The user 104 may also respect a comment or reply to a comment.

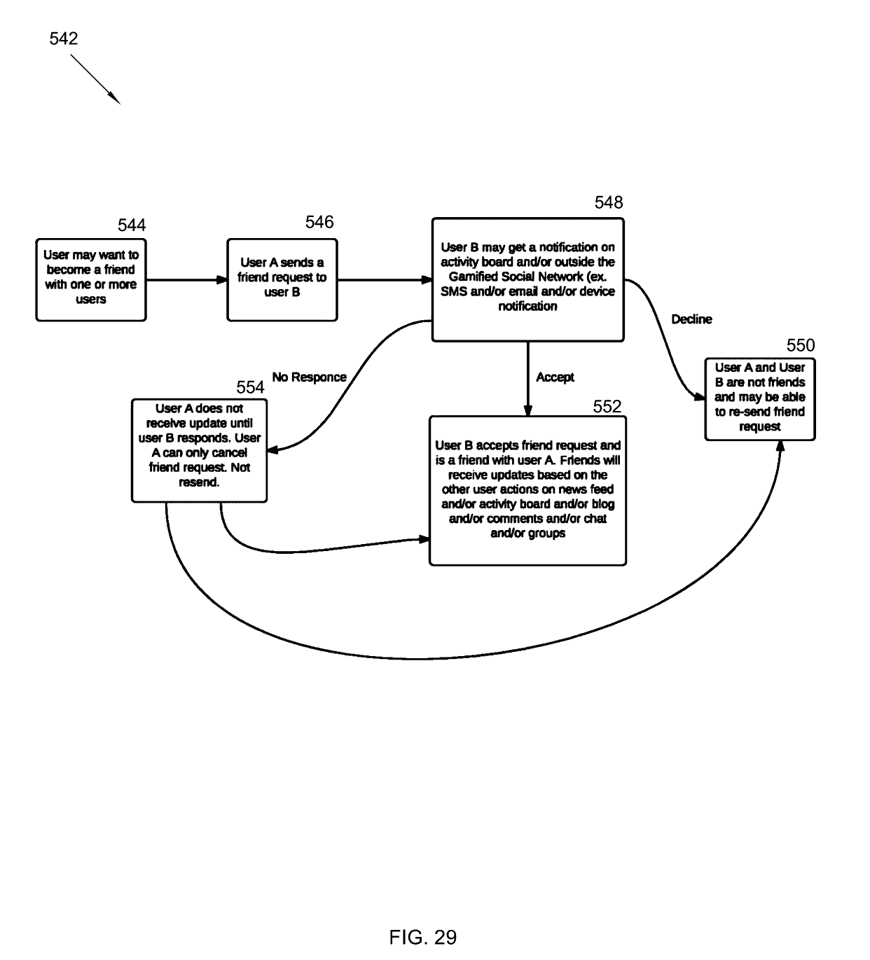

Yet another process 542 for communication 116 between users and group members in the network is referenced in FIG. 29. Here, the user 104 or group 106 may be able to request friends in the network 102 through a friend function. The user 104 or group 106 simply direct the friend function to a desired member 108. In the friend feature, a user 104 and group member 108 must consent to the friendship. The selected friends receive updates on the other user 104 actions on news feed, activity board, blog, comments, and chats between user 104 and group members 108.

Process 542 comprises an initial Step 544 of User A wanting to become a friend with group members and followers. A Step 546 includes user sending a friend request to desired friend target (User B). A Step 548 may include User B receiving notification on the activity board or outside the network or through email about the friend request. A Step 550 User A and User B are not friends, but can resend friend requests. A Step 552 User B accepts friend request. The friends receive updates on the other user's actions on news feed or activity board or blog or comments or chat. A Step 554, User A does not receive update until User B responds. User A can only cancel friend request, not resend.

In yet another form of communication 116, the user 104 and group 106 have access to a news feed screen. Through the news feed screen, the user 104 remains updated on group members 108, challenges 110, achievements 120, news, and advertisements provided on a regular basis for companies, VIP's, followed users 104, friends, and group members 108.

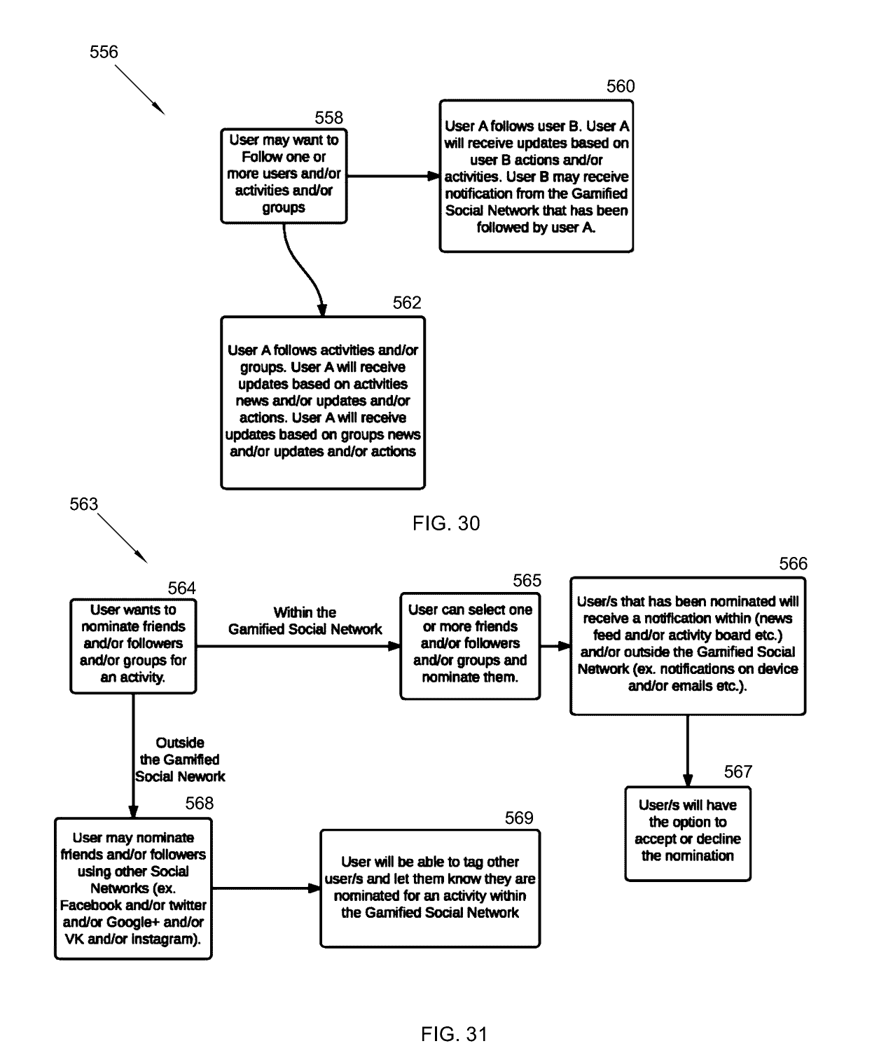

Yet another process 556 for communication 116 between users and group members in the network is referenced in FIG. 30. The system 100 enables the user 104 or group member 108 to follow each other. The followers may receive updates on the user's actions. The user 104 and group member 108 may also follow and have followers through use of a follow function. The followed user 104 or member 108 may receive updates on the registered entity's actions. Users 104 may also follow other users 104, challenges 110, and achievements 120.

As FIG. 30 references, process 556 includes an initial Step 558 of user wanting to follow other group members or friends. Step 560 User A follows User B. User A receives updates based on User B actions and activities. In Step 562, User A follows activities of groups. User A receives updates based on group actions and activities.

The user 104 may have access to news feed screen. Through the news feed screen, the user 104 or group 106 can stay updated on news, activities, actions, and ads that are provided on a regular basis for members 108 of the group 106, VIP's 128, organizational users 130, companies, followers, and friends.

In yet another form communication 116, the user 104 may perform a favorite function for the activity. The user 104 may have selected some action or activity as a favorite. The favorite function may be displayed on the user's 104 profile and may be publicly or selectively available to group members 108.

A process 564 for nominating is shown in FIG. 31. Here, the user 104 and group 106 may perform a nominate function to nominate the group 106, other users 104, challenge 110, or achievement 120. In nominating, the user 104 and group 106 may nominate each other to perform a challenge 110 or activity. In nominating, some of or all other users 104, dependent on user 104 type and demographic, can participate in a challenge 110, even if not directly challenged by a user 104 or group member 108.

As FIG. 31 references, process 563 includes an initial Step 564 of User wanting to nominate friends or followers or groups to perform a challenge. Within the network 102, a Step 565 allows user to select one or more friends or followers or groups for nomination. In a Step 566, the nominated user receives notifications within the newsfeed or activity board. A Step 567 allows users the option to accept or decline the nomination. Outside the network 102, a Step 568 allows user to select one or more friends or followers or groups for nomination from other social networks. A Step 569 user may allow users to tag other users to let them know they are being nominated or inform them through hash-tags.

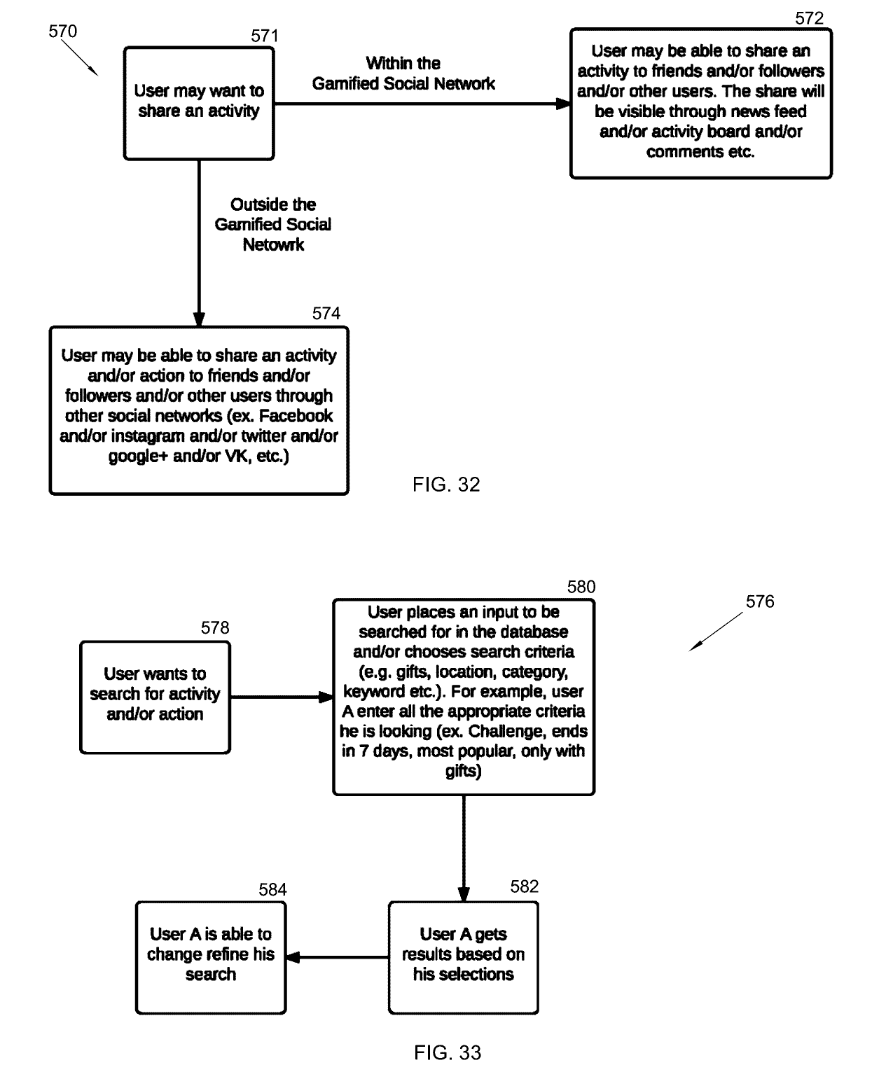

Yet another process 570 for communication 116 between users and group members in the network is referenced in FIG. 32. Further, FIG. 32 illustrates that the user 104 or group 106 may utilize a share function to enable sharing of information regarding their profiles, challenges 110, achievements 120 in or out of the network 102. Using a key function, users 104 can share the challenge 110 or activity.

As FIG. 32 references, process 570 includes an initial Step 571 of user wanting to share an activity. Within the network 102, a Step 572 allows user to share the challenge with friends or group members. The share is visible through the newsfeed. Outside the network 102, a Step 574 allows user to share to other social networks, such as Facebook®, Twitter®, Instagram®, or Google®.

As referenced in FIG. 33, the system 100 may also have process 576 to perform a search, where a user 104 can search for other users 104, group members 108, challenges 110, and achievements 120. The process 576 includes an initial Step 578 of user wanting to search for an activity. A Step 580 includes inputting data to perform the search in a database. The search criteria is selected. For example, User A enters search criteria: [challenge, ends in 7 days, most popular, only with gifts]. In Step 582, User A gets results based on criteria. In Step 584 User A may change the search criteria.

As referenced in FIG. 40, the system 100 also utilizes a process 660 to operate a key teaser 114. For the key teaser 114, the user 104 sets the key functionality, and then the teaser function can be additionally selected. That is, the key creator will hide the action and activity, and then assign a task. Users 104 who need to complete the task, will have to provide sufficient evidence of (successful) completion for the key-teaser creator to unlock it for every, or part of, the selected key members.

The process 660 for the key teaser comprises an initial Step 662 of the user selecting the key functionality to adjust availability of actions and/or activities. Keys may be assigned to groups or specific users or the public, or all. For example, User A assigns a key 114 to User B for a comment. A Step 664 may include a user, such as User A choosing to add the key 114 functionality. A Step 666 includes User A giving a task to User B through the teaser key 114 that must be completed in order to unlock the comment and make it available to User B.

A Step 668 comprises User B providing sufficient evidence of successful completion for the key teaser to unlock it for all, or part of the selected key members. A Step 670 is used in a case where User A assigns a group key; then User A can select only the first to be able to see the comment, all who have completed the activity to see the comment; or id a number of users have completed the activity, the comment may be visible to all members and users, or unlocked for all to see.

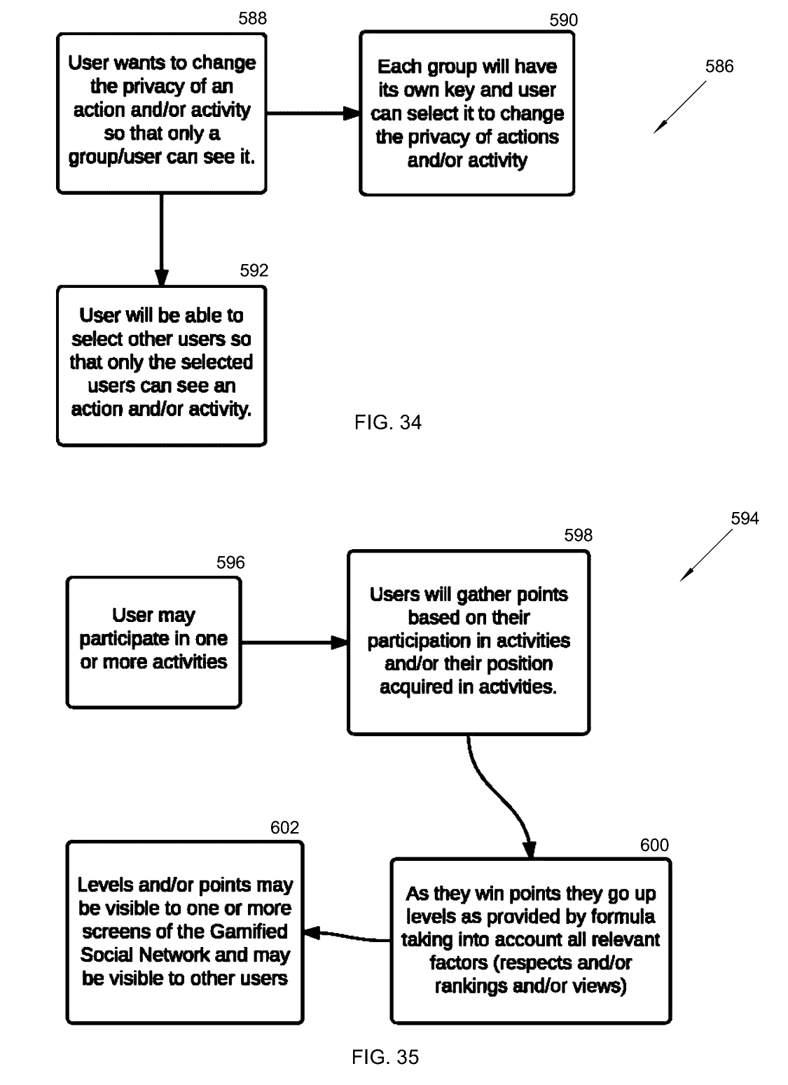

As FIG. 34 illustrates, a process 586 for changing privacy features is allowed in the system 100. The user 104 or group 106 may utilize a key 114 to change privacy settings. With the key function, the user 104 or group 106 can change the privacy of an action or activity so that only a selected number of members 108 can see or access the challenge 110, achievement 120, or activity. Different type of users 104 may have access to more elaborate key functionalities.

As FIG. 34 references, an initial Step 588 requires user to want to change the privacy settings for a challenge so that only selected group members can view the challenge or activity. In Step 590, each group has its own key and the user can select to change the settings. In Step 592, the user can select users to allow permission to view the challenge or activity.

As shown in FIG. 35, a process 594 for allowing user and group to achieve advancing levels in the network. The user 104 and group members 108 may acquire different levels. This level function is consistent with gaming, as the user 104 or group 106 accumulates points for performing challenges 110 and activities, and posting achievements 120. As the user 104 achieves more and gains points, the user 104 increase in level through an algorithm that accounts for relevant factors, such as the type of user 104, the time spent on the challenge 110, the type of challenge 110, and the full or partial achievement 120.

The process 594 for achieving levels includes an initial Step 596 of the user participating in one or more challenges. A Step 598 includes the user accumulating points based on their participation in challenges or their position acquired in challenges. A Step 600 allows users, as they accumulate points, to increase in levels. An algorithm determines the level based on relevant factors, such as likes, respects, votes, duration of challenge, and the like. A Step 602 allows the points or levels to be viewable on multiple screens on the network for multiple group members to view.

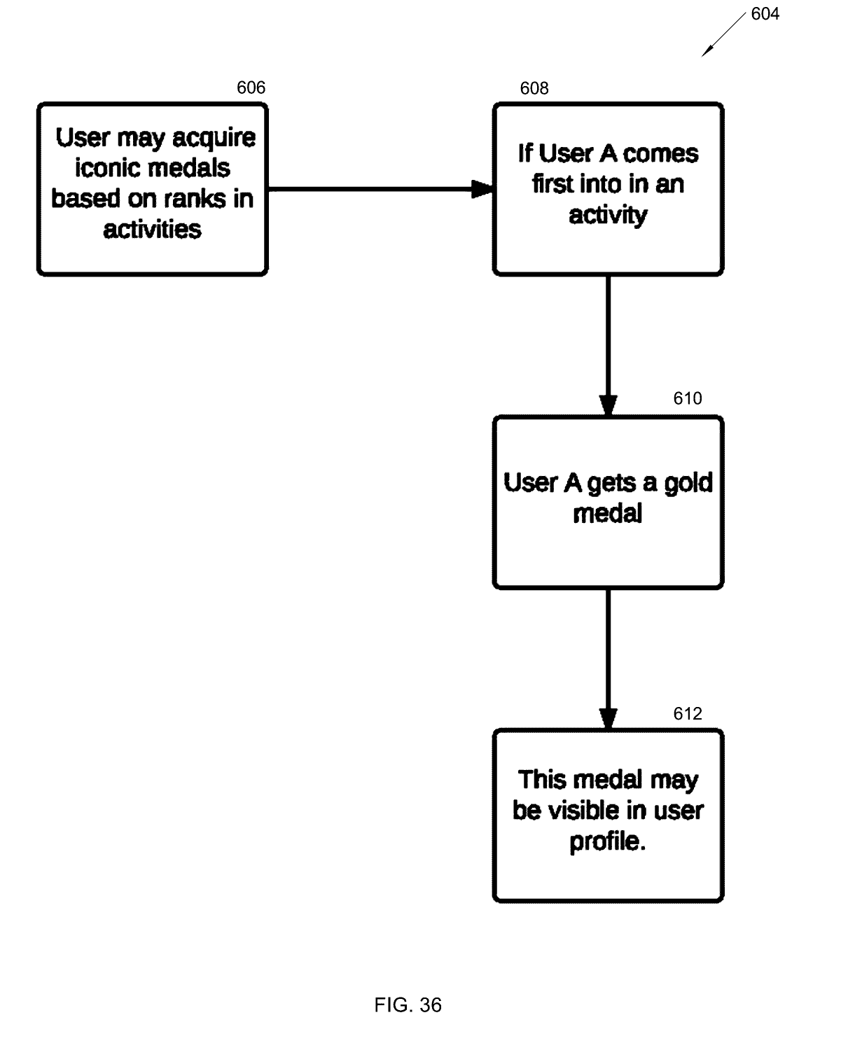

Looking now at FIG. 36, the promotional award 118 may include a medal for achievement 120 or certain challenges 110. In one embodiment, the medal is an iconic medals awarded to a specific number of winners for each challenge 110. A process 604 for acquiring the medal includes an initial Step 606 of the user acquiring medals based on level and challenges attempted. A Step 608 is applicable if a User A comes first into an activity. A Step 610 allows User A to receive a gold medal. A Step 612 allows the medal to be visible in a user profile.

Another form of promotional award 118 is a hall of fame. The hall of fame may include a web page where high achieving users 104 and group members 108 are listed. High achieving users 104 are users 104 that have reached a certain level and/or are within a range of levels and are highly active on the network 102. The hall of fame may utilize different listings of high achievers based on categories, types of users 104, level ranges, and user 104 demographics.

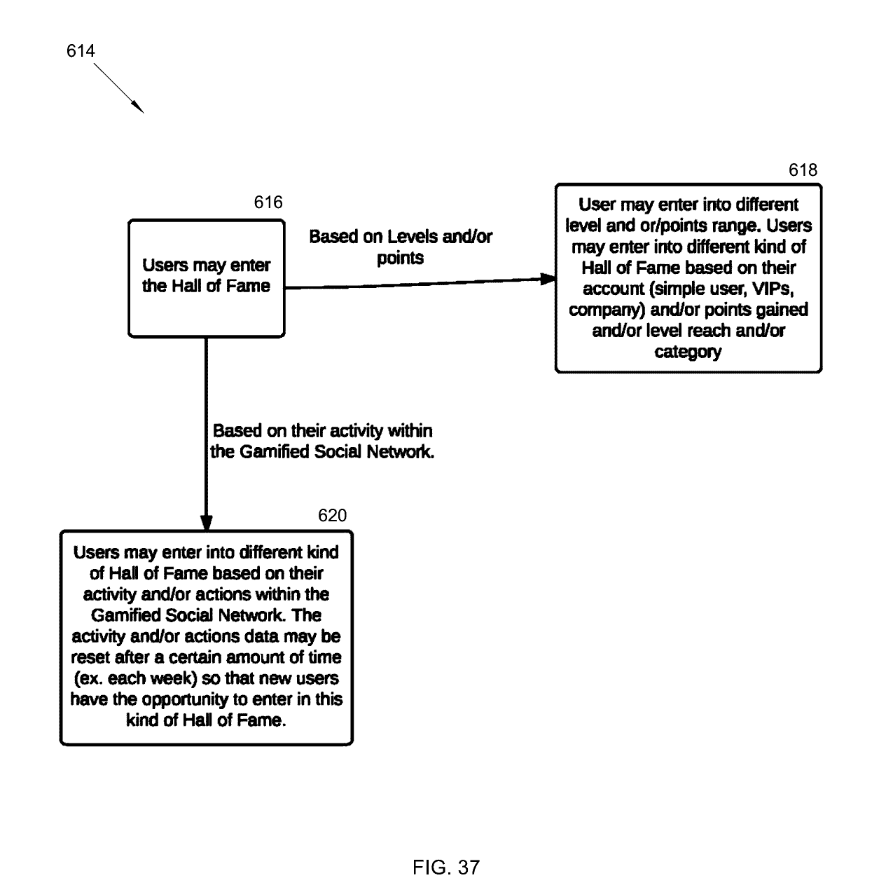

FIG. 37 references a process 614 for entering the Hall of Fame. An initial Step 616 allows users to qualify for the Hall of Fame. In a Step 618, the user may enter into different levels and point ranges. The user enters into different types of Hall of Fame based on their account or points gained, or level or category. A Step 620 requires users to enter different Hall of Fames based on their challenges within the network 102. The challenges may be reset after a duration so that new users have an opportunity to enter that kind of Hall of Fame.

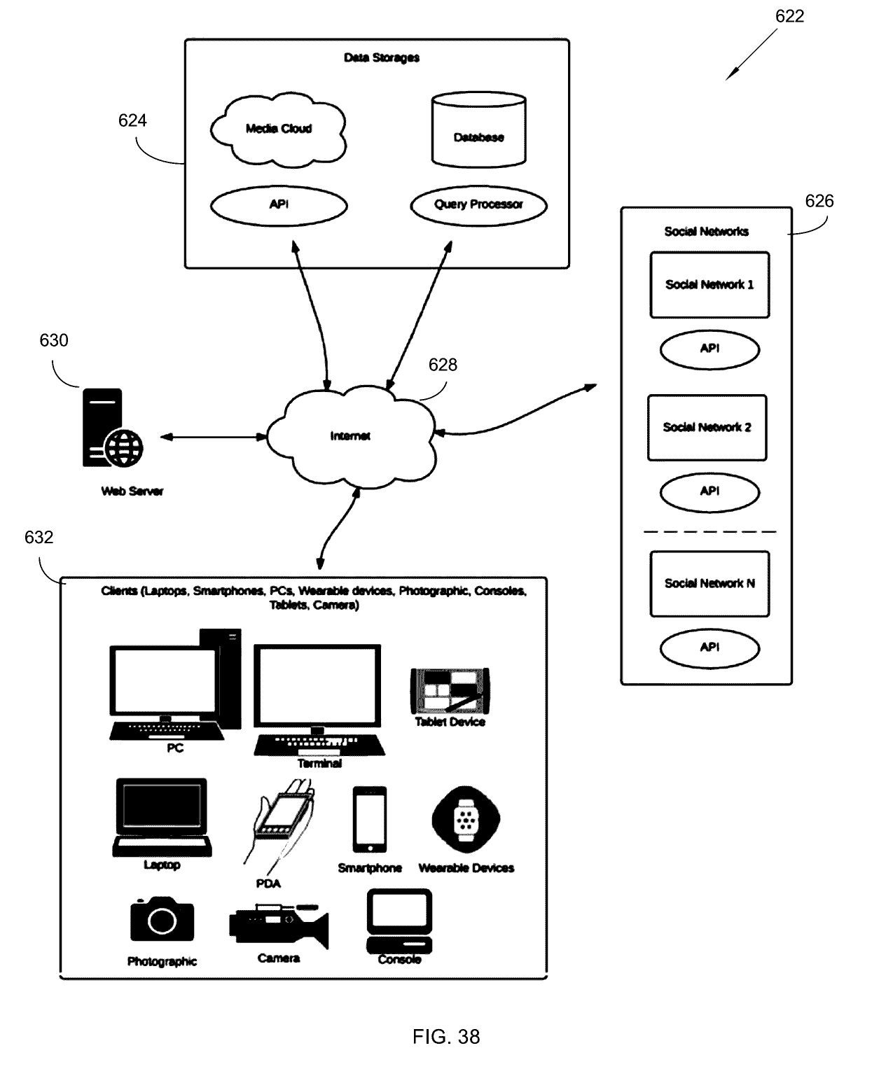

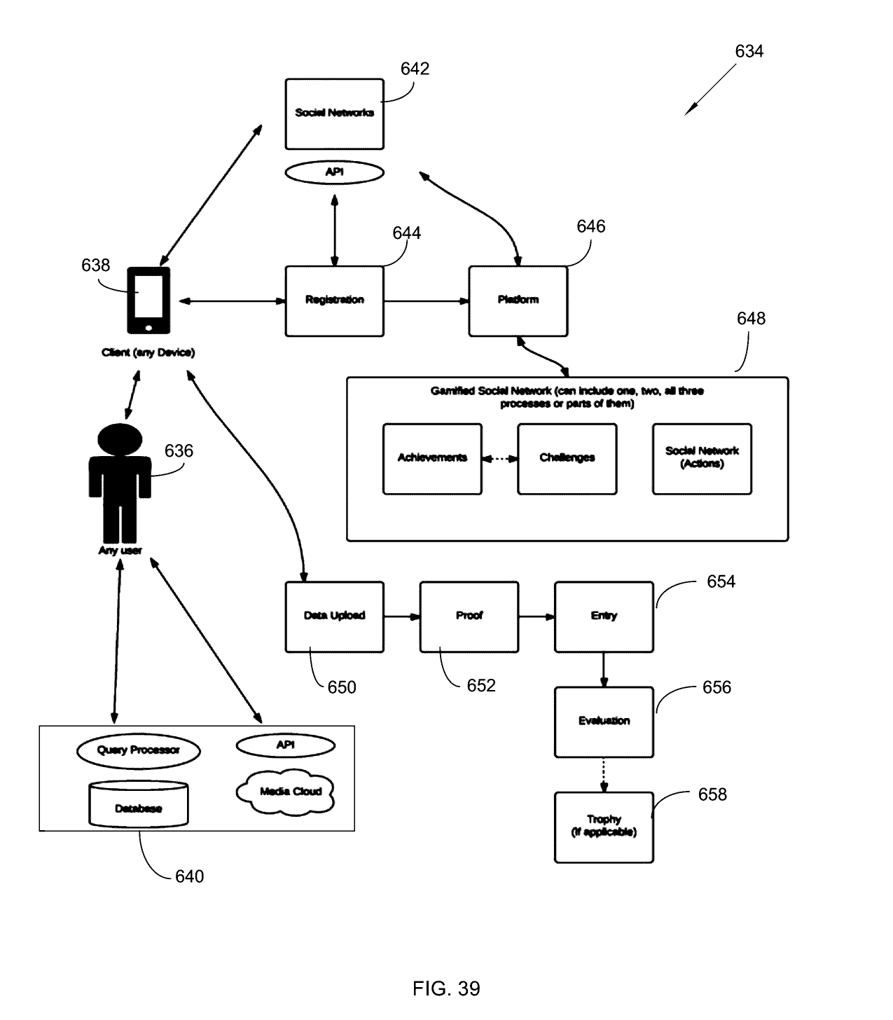

FIG. 38 is a block diagram illustrating a social game system 622. The social game system 622 provides a hardware environment and software environment 624 within which the network may be deployed in certain embodiments. The social game system 622 has application programming interfaces (API) 632 for the social game system 622 to interact with a social network or social networks 626. Provided are a number of interfaces, such as a web server 630, a web interface, and an application program interface (API) 632 to provide respective web interfaces to users 104 and programmatic interfaces to remote systems, through which data is stored and the social network game system is accessible to external data storage systems 624. The social game system 622 is operable through the Internet 628.

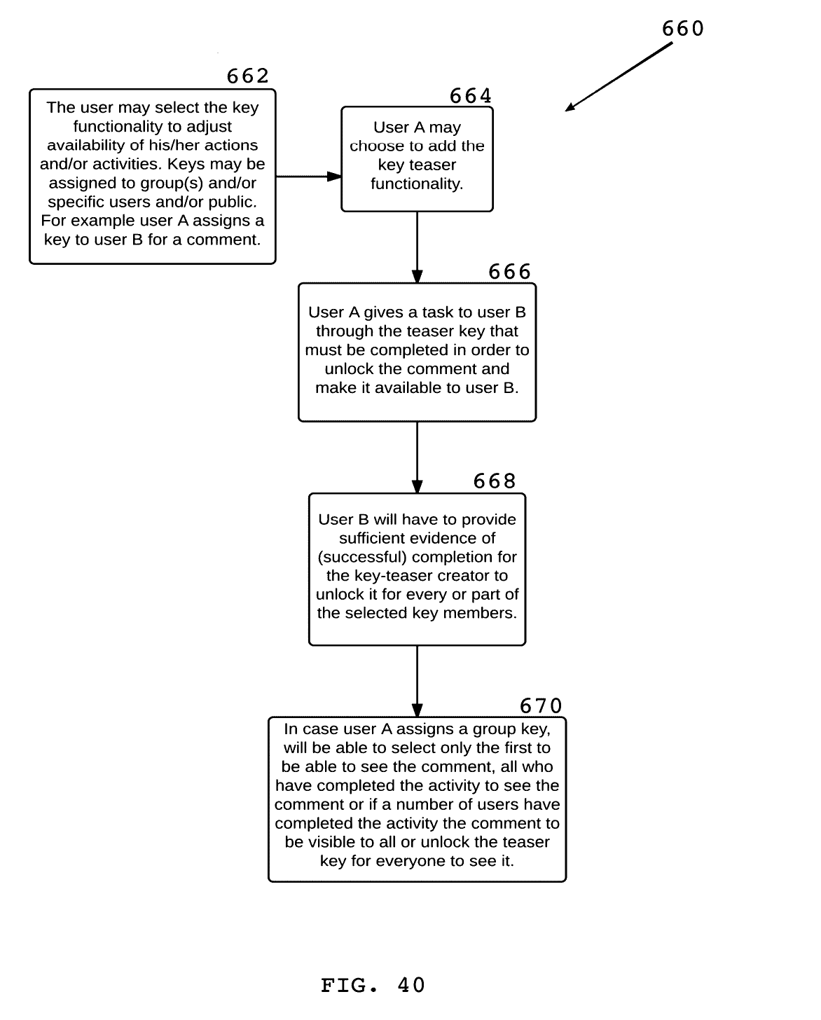

FIG. 39 is a block diagram showing the process 634 by which a user 636 (through a client device) 638 registers for the network connects to social networks and through hardware and software on a platform 646. Process is operable in a client/server system which may be used by an exemplary web-enabled/networked embodiment of the present invention.

A communication system includes a multiplicity of clients 638 with a sampling of clients denoted as a client and a client, a multiplicity of social network 642 with a sampling of networks denoted as a social network 642 and a social network 642, a global network and a multiplicity of servers with a sampling of servers denoted as a server and a server.

Client 638 may communicate bi-directionally with social network 642 via a communication channel. Client may communicate bi-directionally with social network 642 via a communication channel for registration 644 into network. Social network 642 may communicate bi-directionally with global network via a communication channel. Social network 642 may communicate bi-directionally with global network via a communication channel. Through client communication, activities 648 (achievements, challenges, actions) are operable.

Global network may communicate bi-directionally with server and server via a communication channel. Server and server may communicate bi-directionally with each other via communication channel. Furthermore, clients, social network 642, global network and servers 640 may each communicate bi-directionally with each other.

In one embodiment, global network may operate as the Internet. It will be understood by those skilled in the art that communication system may take many different forms. Non-limiting examples of forms for communication system include local area networks (LANs), wide area networks (WANs), wired telephone networks, wireless networks, or any other network supporting data communication between respective entities.

Clients may take many different forms. Non-limiting examples of clients and 2704 include personal computers, personal digital assistants (PDAs), cellular phones and smartphones.

Client includes a CPU, a pointing device, a keyboard, a microphone, a printer, a memory, a mass memory storage, a GUI, a video camera, an input/output interface 2744 and a network interface.

CPU, pointing device, keyboard, microphone, printer, memory, mass memory storage, GUI, video camera, input/output interface and network interface may communicate in a unidirectional manner or a bi-directional manner with each other via a communication channel. Communication channel may be configured as a single communication channel or a multiplicity of communication channels.

CPU may be comprised of a single processor or multiple processors. CPU may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

CPU enables data upload 650 from client 638. Data can be a challenge that requires proof 652. The proof is entered 654 into one of clients listed above. An evaluation 656 may also be performed. A trophy 658 can also be delivered physically or through client 638.

As is well known in the art, memory is used typically to transfer data and instructions to CPU in a bi-directional manner. Memory, as discussed previously, may include any suitable computer-readable media, intended for data storage, such as those described above excluding any wired or wireless transmissions unless specifically noted. Mass memory storage may also be coupled bi-directionally to CPU and provides additional data storage capacity and may include any of the computer-readable media described above. Mass memory storage may be used to store programs, data and the like and is typically a secondary storage medium such as a hard disk. It will be appreciated that the information retained within mass memory storage, may, in appropriate cases, be incorporated in standard fashion as part of memory as virtual memory.

Finally, CPU optionally may be coupled to network interface which enables communication with an external device such as a database or a computer or telecommunications or internet network using an external connection shown generally as communication channel, which may be implemented as a hardwired or wireless communications link using suitable conventional technologies. With such a connection, CPU might receive information from the network, or might output information to a network in the course of performing the method steps described in the teachings of the present invention.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A non-transitory computer readable medium comprising a set of instructions for generating challenges and awarding promotional awards through a gamified network, the instructions executable by a computer having a processor and a memory, the set of instructions to direct the processor to perform the acts of:
joining, by the user, a group that forms a network;
presenting a challenge to the user or the group;
joining a challenge alone, or against a program, or against the network, or against the group, or all;
evaluating the challenge, or the performance of the challenge by the user or the group; and
communicating about the challenge or the user or the group performing the challenge, the communication being operable between the user, the group, and the network.

2. The instructions of claim 1, further including a step of awarding a promotional award to the user or the group that successfully accomplish an achievement of the challenge, the promotional award comprising a marketing indicia.

3. The instructions of claim 2, wherein the promotional award includes at least one of the following: a trophy, a medal, a ribbon, cash, a voucher, and a check.

4. The instructions of claim 3, wherein the marketing indicia comprises at least one of the following: a logo, a text, an image, a coupon, and a voucher.

5. The instructions of claim 1, wherein the step of monetizing the network further comprises charging a fee to a creator of the challenge, or a participant in the challenge, or a proprietor of the marketing indicia on the promotional award.

6. The instructions of claim 1, further including a step of providing a proof that the challenge has been completed or successfully accomplished.

7. The instructions of claim 1, wherein the network is a social network.

8. The instructions of claim 1, wherein the challenge includes at least one of the following: a direct challenge, a logo challenge, a sponsored challenge, a cooperation challenge, a target challenge, a pay to participate challenge, a money reward challenge, a prize reward challenge, a dare challenge, and a predefined challenge.

9. The instructions of claim 1, wherein the communication comprises at least one of the following: a comment, a respect function, a like function, a vote function, a text message, an email, a news feed, a rating, and an evaluation.

10. The instructions of claim 1, wherein the step of evaluating the challenge comprises rating the user, the group, or the challenge on a predefined scale.

11. The instructions of claim 1, further include a feature of a Beat Achievement, a Key Teaser, and a GPS-Active Chat.

12. A non-transitory computer readable medium comprising a set of instructions for generating challenges and awarding promotional awards through a gamified network, the instructions executable by a computer having a processor and a memory, the set of instructions to direct the processor to perform the acts of:
registering a user in the network;
creating a task assignment for the user or the group;
selecting at least one evaluation method;
setting a deadline for the task assignment; and
assigning a promotional award to the user or the group that successfully accomplish the task.

13. The instructions of claim 12, wherein the promotional award includes at least one of the following: a trophy, a medal, a ribbon, cash, a voucher, and a check.

14. The instructions of claim 12, wherein the evaluation method is a measurable method or an immeasurable method.

15. The instructions of claim 14, wherein the measurable evaluation method comprises any challenge involving a task that can be quantified.

16. The instructions of claim 15, wherein the immeasurable evaluation method comprises any task where the evaluation can be based on votes or comments, or likes, or all that have accumulated.

17. The instructions of claim 12, further including a method where users prove completion or accomplishment of the task based on data taken from a computer having a processor, including a memory.

18. An automated system for processing a sponsor challenge, comprising:
a computer having a processor, a memory, and a communications system, the computer connected to a network, wherein the processor is configured to:
notifying a User A about interest from User B to sponsor a challenge or an achievement;
if, the approval of User A is not required, providing, by User B, a promotional award to a winner of the sponsored challenge or the achievement;
if approval from User A is declined, notifying User B and allowing User B a chance to negotiate with User A;
if approval from User A approved, providing, by User B, the promotional award to the winner; attaching a promotion from the sponsor to the sponsored challenge or the achievement; performing the sponsored challenge or the achievement; and delivering, by User B, the promotional award to the winner, or to User A, or both.

19. The system of claim 18, further including a step of providing a proof that the sponsored challenge has been completed or successfully accomplished.

20. The system of claim 18, wherein the promotional award includes at least one of the following: a trophy, a medal, a ribbon, cash, a voucher, and a check.
